(19) United States
(12) Patent Application Publication
(10) Pub. No.: US 2026/0330249 A1
(43) Pub. Date: Oct. 22, 2026

(54) Human Relational Axes for Relational Positioning in Multi-Agent Systems with Downstream Non-Feedback Preservation

(71) Applicant: Jody Rahsaan Jones, Queens, NY (US)

(72) Inventor: Jody Rahsaan Jones, Queens, NY (US)

(21) Appl. No.: 19/686,919

(22) Filed: May 25, 2026

Related U.S. Application Data
(60) Provisional application No. 63/949,323, filed on Dec. 28, 2025.

(51) Int. Cl. G06N 5/02

(52) U.S. Cl. CPC G06N 5/02

(57) ABSTRACT

The invention discloses a structural relational framework, referred to as the Human Relational Axes (HRA), for representing how agents and non-agentic forces are positioned relative to one another within a communicative or perceptual scene. The framework defines a minimal and complete set of relational axes—Self, Human Other, and Nature—relative to a designated evaluator, enabling representation of relational geometry and admissible directional channels of influence without semantic interpretation, psychological modeling, or evaluative judgment. The HRA distinguish subject-to-subject interaction from non-subjective constraint and represent communicative and perceptive force as structurally available pathways independent of content, authority, or outcome. Relational frames are perspectival but non-privileged, allowing any registered agent to occupy the evaluator position without conferring epistemic or normative authority.

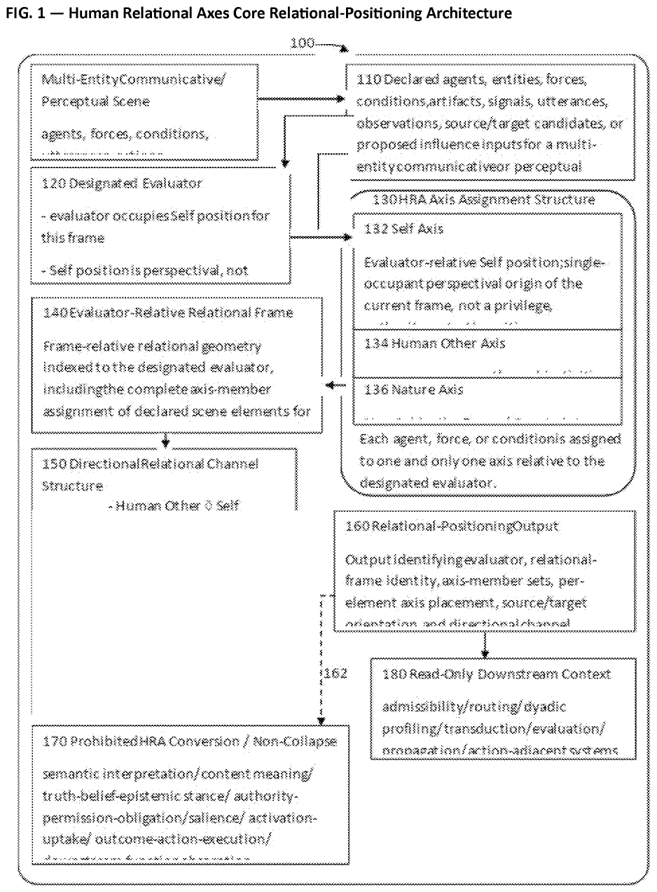

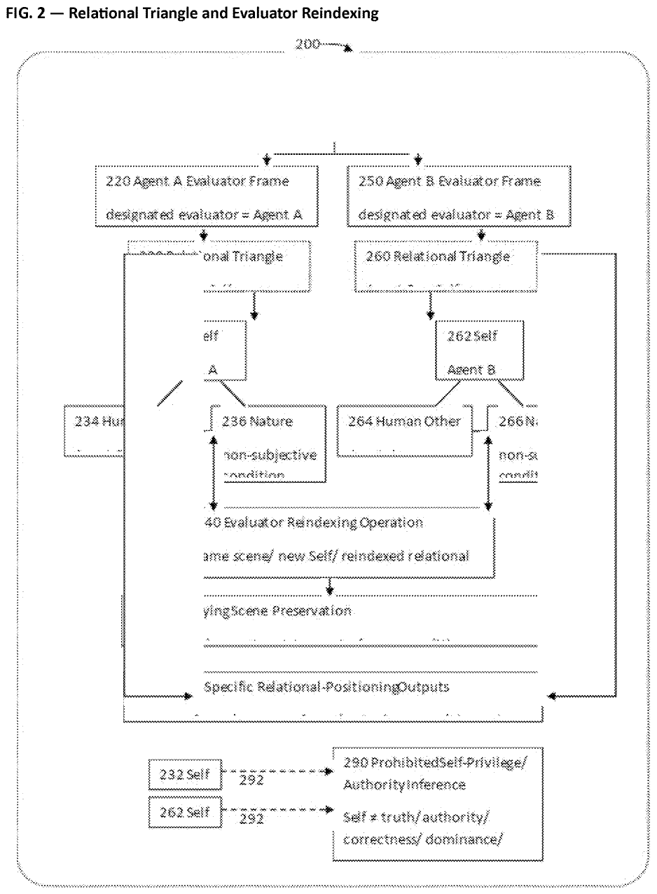

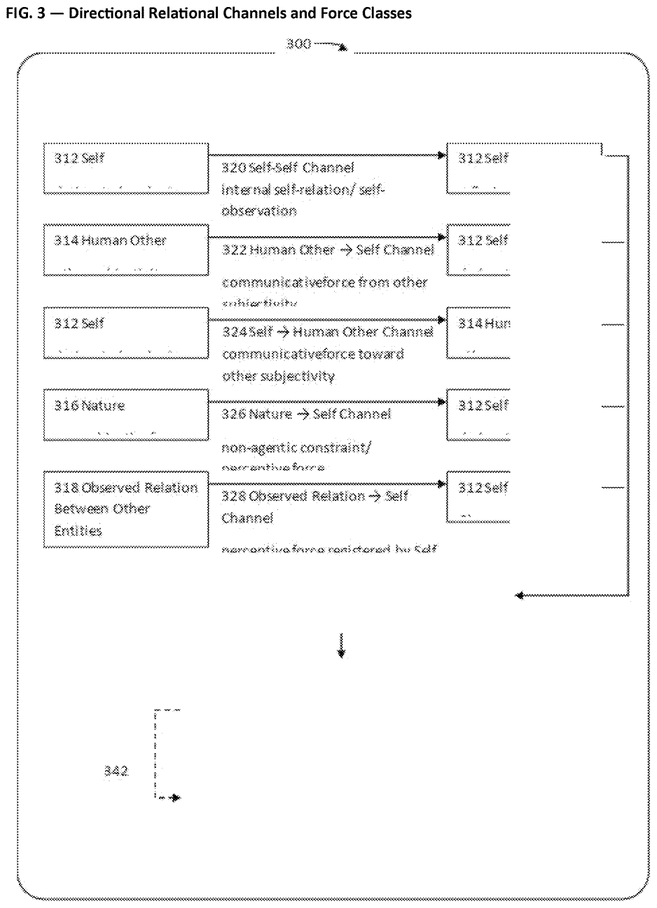

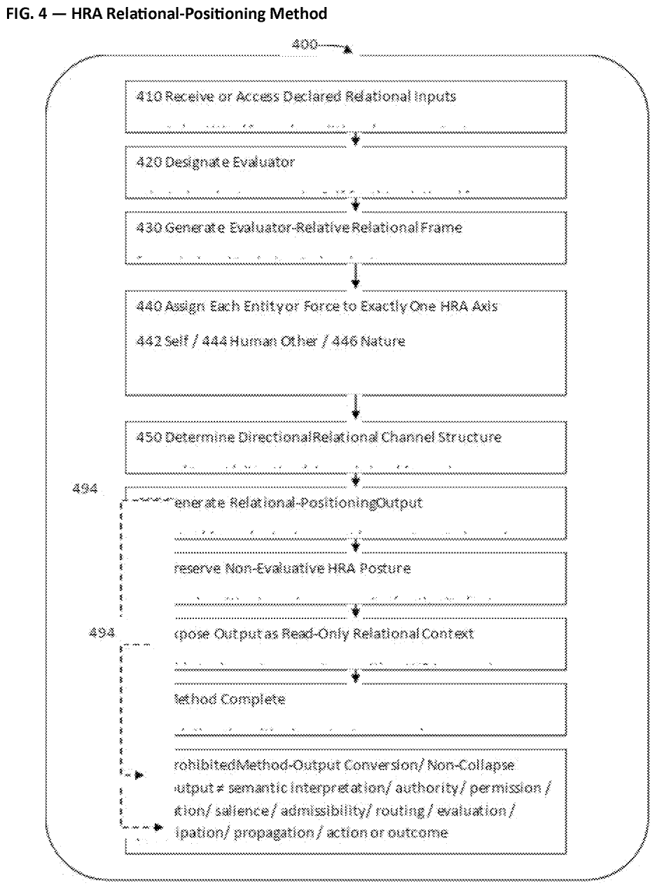

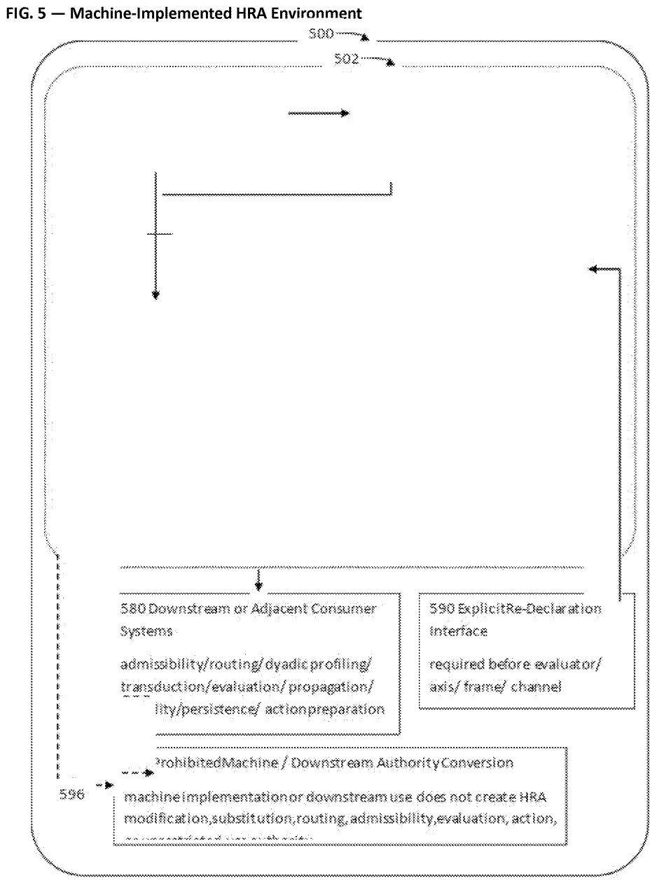

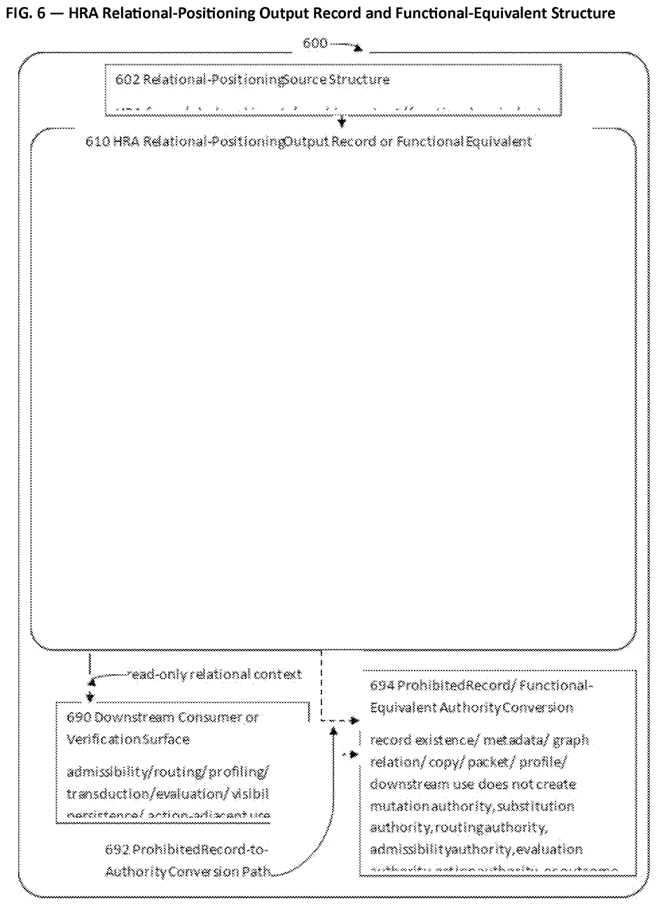

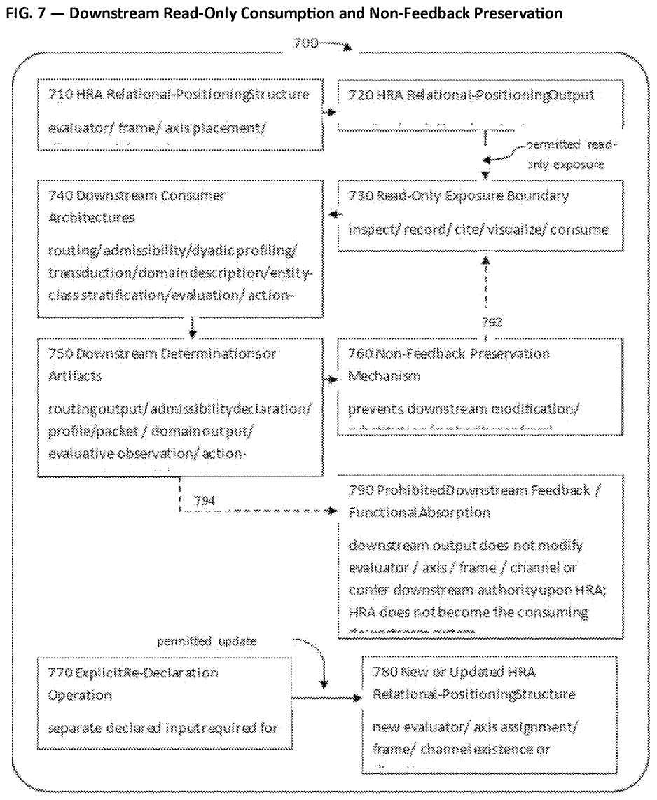

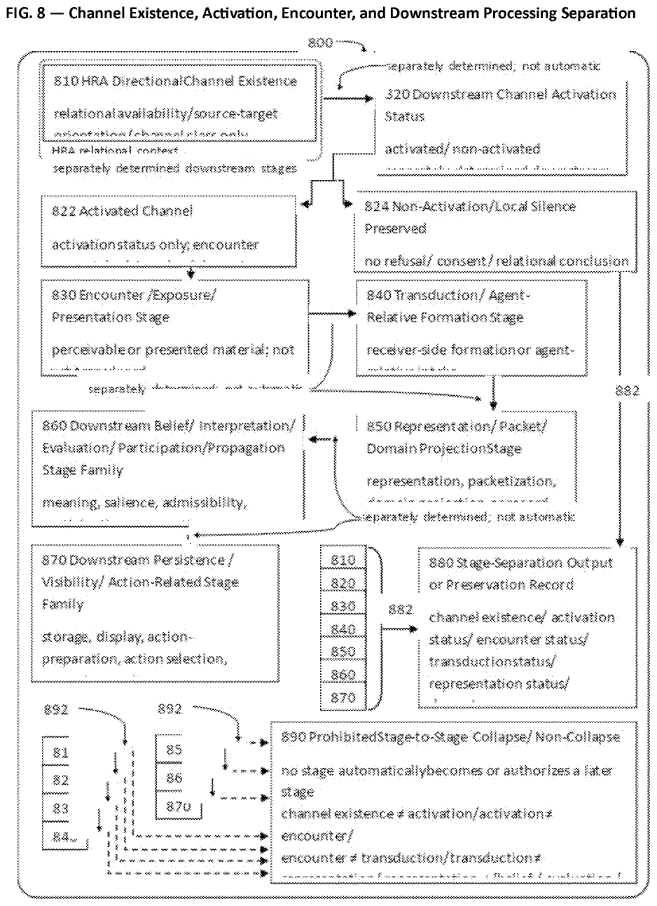

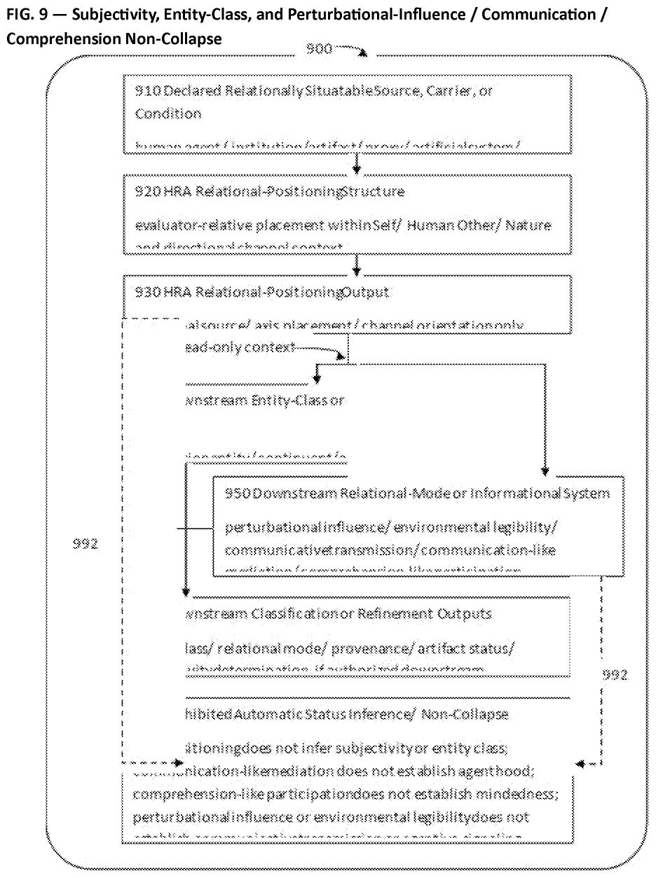

The invention operates as a pre-interpretive, non-evaluative substrate that supplies relational structure as read-only input to downstream systems responsible for epistemic interpretation, participation gating, propagation, or temporal consequence. By separating relational structure from meaning, agent cognition, and temporal authority, the HRA provide a neutral, auditable foundation for modeling interaction across heterogeneous multi-agent environments, including human, institutional, artificial, and non-human evaluators.

### CROSS-REFERENCE TO RELATED APPLICATIONS

This application claims priority to and the benefit of U.S. Provisional Patent Application No. 63/949,323, filed 2025 Dec. 28, entitled “Human Relational Axes: A Structural Framework for Relational Positioning in Multi-Agent Systems”, pursuant to 35 U.S.C. § 119(e), the entire disclosure of which is incorporated herein by reference.

### FIELD OF THE INVENTION

### 1.1 Technical Field

The present invention relates to relational modeling architectures for multi-agent systems, communicative interaction frameworks, and structural representations of interpersonal and environmental influence. More specifically, it concerns a formal relational axis framework for situating agents and non-agentic forces within a shared relational field, such that communicative and perceptive force may be represented independently of semantic interpretation, psychological modeling, or evaluative judgment.

### 1.2 Scope of the Invention

The invention provides systems and methods for representing the relational geometry within which interaction occurs, by defining a minimal and complete set of relational axes relative to a designated evaluator. These axes specify how agents and non-agentic forces are positioned with respect to one another and identify the directional channels along which influence may lawfully flow.

Within the scope of the invention, the relational framework:
represents where influence originates and to whom it is directed,
distinguishes between subject-to-subject interaction and non-agentic constraint, and
defines admissible relational channels without assigning meaning, authority, permission, or outcome.

The invention does not interpret content, evaluate correctness, assign salience, or compute consequence. It establishes the structural relational context within which such downstream operations may occur.

### 1.3 Relationship to Other Systems

The present invention is compatible with epistemic, temporal, and evaluative subsystems that operate over interactional content, including systems for epistemic representation, temporal applicability, participation gating, and propagation control.

The invention does not define agent cognition, epistemic interpretation, temporal ordering, participation evaluation, or consequence determination. Instead, it supplies a pre-interpretive, non-evaluative relational framework that downstream systems may reference when assessing admissibility, relevance, or effect of interaction.

Relational structure defined by the invention is consumed read-only by such systems and is not modified by epistemic evaluation, temporal reasoning, or propagation logic. This separation preserves neutrality, auditability, and modular integration across heterogeneous multi-agent environments.

### BACKGROUND OF THE INVENTION

### 2.1 Limitations of Content-Centric Communication Models

Many existing systems model communication primarily as the transmission of content between entities. In such models, interaction is reduced to the exchange of messages whose meaning is interpreted independently of the relational context in which they occur.

While content-centric approaches support semantic parsing and information retrieval, they fail to represent how the relational positioning of participants conditions the lawful effect of communication. Identical content may be permissible, coercive, irrelevant, or inadmissible depending on the relational configuration between sender and receiver-differences that content-only models cannot capture.

### 2.1.1 Meaning-Only and Message-Passing Frameworks

Meaning-only and message-passing frameworks treat communication as the delivery of informational payloads across neutral channels. These frameworks assume that the channel itself is structurally uniform and that any variation in effect arises from message content or receiver interpretation.

Such assumptions obscure the role of relational structure. They provide no mechanism for representing asymmetries in influence, consent, or exposure that arise from who communicates with whom, under what conditions, and from what relational position. As a result, message-passing systems must infer relational effects indirectly or embed them procedurally, undermining auditability and modularity.

### 2.1.2 Failure to Represent Communicative Force

Communication is not merely informational; it exerts force. Utterances can constrain options, impose urgency, induce obligation, or apply pressure independent of their propositional content.

Content-centric models lack a structural representation of this force. They cannot distinguish between communication that merely informs and communication that directs, pressures, or constrains, except by interpreting content post hoc.

Without an explicit representation of communicative force, systems cannot lawfully assess admissibility, coercion, or consent, and must rely on ad hoc heuristics or implicit assumptions.

### 2.2 Limitations of Agent-Centric and Psychological Models

Other approaches attempt to resolve relational effects by modeling agents as psychological entities possessing beliefs, intentions, preferences, or authority. In these models, relational consequence is derived from inferred internal states or role-based assumptions. Such approaches introduce opacity and inference into relational modeling, making it difficult to distinguish between what is structurally present and what is conjectured.

### 2.2.1 Implicit Authority and Belief Attribution

Psychological and agent-centric models often attribute authority, intent, or credibility to agents based on inferred beliefs or roles. These attributions are rarely explicit and are frequently embedded within evaluation logic.

As a result, authority and permission may be silently assumed rather than structurally represented, allowing power dynamics to enter the system without explicit acknowledgment or constraint.

This undermines neutrality and prevents systematic auditing of how relational effects arise.

### 2.2.2 Conflation of Meaning, Power, and Evaluation

When relational consequence is derived from psychological inference or agent state, meaning, power, and evaluation become entangled. Identical content may be treated differently not because of structural differences, but because of implicit assumptions about the speaker or listener.

Such conflation prevents consistent comparison of communicative acts across agents, scenes, or time, and collapses relational structure into evaluative outcome. A lawful relational framework must separate what is said from what it can do.

### 2.3 Need for a Structural Relational Framework

The limitations above demonstrate the need for a relational representation that is structural, explicit, and pre-interpretive. Such a framework must represent relational positioning independently of content, belief, or evaluation.

### 2.3.1 Communication as Relational Force

Communication operates as a form of relational force exerted within a structured field. This force is directional, asymmetric, and conditioned by the relational positions of the participants. A structural framework must therefore represent not only the presence of communication, but the relational channels through which force may flow, independent of semantic interpretation.

### 2.3.2 Autonomy and Consent as Structural Constraints

The lawful effect of communicative force depends on autonomy and consent. Autonomy is not a property of content, but of the relational configuration between agents. Consent to influence varies by relational context and cannot be inferred reliably from content or agent intent alone. It must be represented structurally.

Accordingly, a relational framework must encode the conditions under which influence is admissible, without determining outcome or enforcing evaluation.

### SUMMARY OF THE INVENTION

### 3.1 Core Contribution

The present invention introduces the Human Relational Axes (HRA), a formal relational framework for representing how agents and non-agentic forces are positioned relative to one another within a communicative or perceptual scene. The invention defines a structural relational geometry that specifies admissible directional channels of influence without interpreting content, modeling cognition, or evaluating outcome.

The Human Relational Axes establish a minimal and complete set of relational categories relative to a designated evaluator, enabling systems to represent where influence originates, how it is directed, and what kinds of relational force are structurally admissible. By isolating relational structure as a first-class primitive, the invention separates relational context from semantic meaning, agent psychology, and evaluative consequence.

This framework provides a stable relational substrate upon which downstream systems may lawfully assess admissibility, relevance, and effect of interaction, while preserving neutrality, auditability, and modular integration across heterogeneous environments.

### 3.2 Key Characteristics

### 3.2.1 Relational Geometry Independent of Meaning

A key characteristic of the invention is that relational positioning is represented independently of semantic content. The Human Relational Axes do not encode meaning, truth, intent, or propositional structure. Identical content may traverse different relational channels and exert different lawful effects solely due to differences in relational configuration. By representing relational geometry separately from meaning, the invention enables consistent comparison of communicative acts across agents, scenes, and time, without collapsing relational consequence into semantic interpretation.

### 3.2.2 Non-Evaluative, Pre-Interpretive Structure

The Human Relational Axes operate as a pre-interpretive and non-evaluative framework. They do not assign authority, permission, salience, or outcome, and they do not compute coercion, obligation, or consent.

Instead, the axes define structural availability: which relational channels exist and which forms of influence are admissible for consideration by downstream evaluative systems. All judgment, weighting, and consequence determination are explicitly deferred to systems external to the HRA.

This separation ensures that relational structure remains neutral and inspectable, and that evaluative logic cannot be silently embedded within relational representation.

### 3.2.3 Self-Relative but Non-Privileged Evaluation Frames

The relational framework defined by the invention is self-relative. For any given evaluation, a designated entity occupies the Self position, and relational structure is defined relative to that position. This perspectival anchoring is necessary to represent autonomy and consent without asserting global authority.

At the same time, the Self position is non-privileged. Any registered agent capable of occupying a relational position may serve as the evaluator without modification to the relational framework. No ontological, cognitive, or moral privilege is conferred by occupying the Self role.

This evaluator interchangeability enables the Human Relational Axes to operate uniformly across human, institutional, artificial, or other non-human agents, preserving neutrality while supporting consistent relational analysis.

### DEFINITIONS

### 4.1 Relational Frame

A Relational Frame is a structural context in which agents and non-agentic forces are situated relative to a designated evaluator. The relational frame defines the positions of entities within a shared relational geometry and specifies the directional channels along which influence may be considered.

A relational frame is perspectival, not ontological. It is defined relative to the entity occupying the evaluator position and does not assert objective centrality, authority, or privilege. Changing the evaluator reindexes the relational frame without altering the underlying agents or forces present.

The relational frame encodes structural availability of influence, not interpretation, relevance, or outcome.

### 4.2 Human Relational Axes (hra)

The Human Relational Axes (HRA) are a minimal and complete set of relational categories used to situate agents and non-agentic forces within a relational frame. The axes define how entities relate to the evaluator and determine which forms of relational influence are structurally admissible.

The HRA consist of exactly three axes: Self, Human Other, and Nature. Each entity or force within a relational frame is assigned to one and only one axis relative to the evaluator. The axes are categorical and exclusive at the level of representation and do not encode meaning, authority, or evaluation.

### 4.2.1 Self

Self denotes the entity occupying the evaluator position within a relational frame. The Self is the point of reference for relational positioning and the locus with respect to which autonomy and consent are assessed.

Designation as Self does not imply correctness, authority, or dominance. It establishes only the perspectival origin from which relational effects are evaluated. Only one entity may occupy the Self position within a given relational frame.

### 4.2.2 Human Other

Human Other denotes another agent treated as a subjectivity capable of reciprocal influence relative to the Self. Assignment to the Human Other axis asserts the presence of another mind and admits bidirectional relational channels.

The Human Other axis does not imply trust, alignment, authority, or intent. It specifies only that interaction involves another subjectivity whose autonomy must be structurally respected.

### 4.2.3 Nature

Nature denotes non-subjective forces that exert influence on the Self without intention or consent. Nature includes physical environment, biological constraints, institutional systems, and other impersonal conditions.

Assignment to the Nature axis asserts absence of subjectivity and absence of consent. It does not imply benignity, hostility, or inevitability.

### 4.3 Relational Triangle

The Relational Triangle is the canonical structural representation of the Human Relational Axes in use. It depicts the relational frame as a triadic configuration with vertices corresponding to Self, Human Other, and Nature.

Within the Relational Triangle, agents and forces are positioned relative to the Self, and directional channels of influence are represented as connections between vertices. The Relational Triangle functions as a structural diagram analogous to a free-body diagram, representing relational positioning without encoding semantic or evaluative content.

The Relational Triangle is invariant under rotation of the evaluator position: any agent may occupy the Self vertex, yielding a new relational frame without altering the underlying structure.

### 4.4 Communicative and Perceptive Force

Communicative and perceptive force refers to the structural influence exerted within a relational frame by utterances, actions, or observable conditions. Force is directional, originating from a source entity or condition and acting upon a target relative to the Self. Force is distinct from content. An utterance activates a communicative force channel but does not create the relational channel itself. Perceptive force may arise from non-agentic conditions or from observation of interaction between other entities.

Communicative and perceptive force describe availability of influence, not interpretation, obligation, or outcome.

### DETAILED DESCRIPTION OF THE INVENTION

### 5.1 The Human Relational Axes Framework

The Human Relational Axes (HRA) define a structural relational framework for situating agents and non-agentic forces within a communicative or perceptual scene. The framework specifies a minimal relational geometry relative to a designated evaluator and establishes the categories through which influence may be considered.

The HRA do not operate on content, do not perform interpretation, and do not compute outcomes. They define relational positioning only, providing the structural context within which downstream systems may evaluate admissibility, relevance, and effect of interaction.

The framework is pre-interpretive and non-evaluative. It encodes where influence originates, how it is directed, and what relational channels are structurally available, without assigning meaning, authority, or consequence.

### 5.1.1 Triadic Relational Sufficiency

The HRA are composed of exactly three relational categories: Self, Human Other, and Nature. These categories are sufficient to situate all communicative and perceptual forces that may act upon an evaluator.

Self establishes the perspectival origin of evaluation. Human Other captures interaction with another subjectivity capable of reciprocal influence. Nature captures all non-subjective forces that exert influence without intention or consent.

No additional relational categories are required. Any communicative or perceptual influence can be structurally situated within this triadic framework without loss of generality.

### 5.1.2 Categorical Exclusivity and Completeness

Within a given relational frame, each entity or force is assigned to one and only one of the three Human Relational Axes relative to the evaluator. The axes are categorical and mutually exclusive at the level of representation.

This exclusivity ensures clarity of relational positioning and prevents conflation of agentic and non-agentic influence. At the same time, the triadic set is complete: no relevant influence lies outside the representational scope of the axes.

Axis assignment is frame-relative and does not modify the underlying entity or force. Changing the evaluator produces a new relational frame without altering the entities present.

### 5.2 The Relational Triangle Representation

The Relational Triangle is the canonical structural representation of the Human Relational Axes in use. It models the relational frame as a triadic configuration with vertices corresponding to Self, Human Other, and Nature.

The Relational Triangle serves as a structural diagram that makes explicit the relative positioning of agents and forces and the directional channels through which influence may occur. It does not encode semantic content, evaluative judgment, or temporal progression.

The Relational Triangle is perspectival. Any agent may occupy the Self position for purposes of evaluation, and the triangle may be reindexed accordingly. This reindexing preserves structural relationships while shifting the origin of evaluation.

### 5.2.1 Relational Nodes and Perspective

Within the Relational Triangle, each vertex represents a relational category rather than a specific entity. Agents and forces are positioned relative to these vertices based on their assignment within the current relational frame.

Perspective is established by designating a Self vertex. All relational positioning, channel directionality, and admissibility assessment are defined relative to this vertex. Perspective does not imply privilege, authority, or correctness.

### 5.2.2 Frame Relativity and Self Reassignment

The HRA framework supports reassignment of the evaluator position without altering relational structure. When a different agent is designated as Self, the relational frame is reindexed, and entities previously classified as Human Other or Nature may shift position accordingly.

This reassignment enables consistent relational analysis across agents, scenes, and viewpoints while preserving neutrality and comparability. No relational information is lost or recomputed; only the perspectival origin changes.

### 5.3 Force Vectors and Directionality

Relational influence within the HRA framework is represented through directional force vectors. A force vector denotes a structural channel along which influence may act from a source toward a target relative to the evaluator.

Force vectors are directional and asymmetric. The existence of a channel from one entity to another does not imply the existence or equivalence of the reverse channel. Directionality is a structural property, not an evaluative one.

Force vectors exist independently of any particular utterance or action. An utterance or observable condition activates an existing channel but does not create the relational channel itself.

### 5.3.1 Directional Channels of Influence

Directional channels specify the admissible pathways through which communicative or perceptive force may be considered. These channels differentiate, for example, influence originating from another subjectivity from influence originating in non-agentic conditions.

Channels define availability of influence, not obligation, acceptance, or outcome. Whether influence is admitted, weighted, or acted upon is determined exclusively by downstream systems.

### 5.3.2 Distinction Between Channel and Content

The HRA framework explicitly distinguishes between relational channels and epistemic content. Relational channels define where and how influence may flow; content defines what is expressed.

This distinction prevents meaning, authority, or evaluation from being embedded in relational representation. Identical content may traverse different channels and exert different lawful effects solely due to differences in relational configuration.

The HRA framework supports multiple levels of relational mapping to account for how influence may be registered, perceived, or observed within a relational frame. These levels distinguish the origin and registration of relational force without asserting interpretation, relevance, or outcome.

The levels are structural distinctions only. They do not impose hierarchy, priority, or evaluative weight.

### 5.4.1 Agent State (Self-Self)

At the agent-state level, relational mapping includes Self-Self channels representing internal self-relation. These channels capture the fact that an evaluator may register influence arising from internal perception, reflection, or self-observation.

Self-Self channels are structurally present but private by default. They are not observable to other agents unless explicitly externalized. The HRA framework does not interpret the content of self-relation and does not expose it as communicative force unless it is expressed.

### 5.4.2 Interpersonal Relational Channels

Interpersonal channels represent direct relational pathways between the Self and other agents classified as Human Other. These channels admit bidirectional influence, subject to relational admissibility constraints defined elsewhere.

Interpersonal channels encode the availability of reciprocal communicative force between subjectivities. They do not encode trust, authority, alignment, or consent. Such properties are evaluated downstream using explicit structural inputs.

### 5.4.3 Observational and Perceived Forces

The HRA framework also represents observational channels, through which the Self may register force arising from the perception of interactions between other entities. Observational force does not originate from a direct communicative act toward the Self, but from perception of relational dynamics elsewhere in the frame. These channels allow modeling of indirect influence without inferring intent, belief, or consequence.

### 5.5 Structural Invariants of the Human Relational Axes

The Human Relational Axes obey a set of structural invariants that preserve neutrality, auditability, and modular integration.

### 5.5.1 Non-Evaluativity

The HRA do not perform evaluation. They do not assign authority, permission, salience, obligation, or outcome. They encode relational availability only.

All evaluative judgments are deferred to downstream systems operating over explicit structural inputs.

### 5.5.2 No Authority, Permission, or Outcome Encoding

Relational positioning within the HRA does not grant authority, confer permission, or imply entitlement. The existence of a relational channel does not determine whether influence is admitted or acted upon.

Outcome determination is explicitly outside the scope of the HRA.

### 5.5.3 Orthogonality to Epistemic and Temporal Systems

The HRA are orthogonal to epistemic representation and temporal architecture. They do not encode meaning, belief, truth, or stance, and they do not define temporal ordering, progression, or duration.

The HRA supply relational geometry only. Epistemic interpretation, temporal applicability, and consequence propagation are handled by independent systems that consume HRA structure as read-only input.

### 6. Relationship to Other System Components

### 6.1 Relationship to Agent Substrates

The Human Relational Axes (HRA) operate in conjunction with agent substrates that supply structural boundary conditions for interaction. The HRA define relational geometry, while agent substrates define agent-specific constraints within that geometry.

The invention does not define agent structure, agent cognition, or agent behavior. It defines how relational positioning is represented independently of agent-internal properties.

### 6.1.1 Agents as Relational Boundary Conditions

Within the HRA framework, agents function as relational boundary conditions rather than as sources of evaluation or interpretation. Agent substrates supply categorical and structural parameters—such as ontological traits, time-binding admissibility, and latent social structure—that constrain which relational channels may be considered admissible within a given relational frame.

The HRA do not derive these constraints and do not infer agent properties. They provide the relational context within which agent-supplied constraints may be applied by downstream systems.

### 6.1.2 Read-Only Consumption of Agent Structure

Agent structure is consumed by the HRA read-only. The HRA do not modify agent records, activate roles, re-anchor history, or update agent-side parameters.

Relational positioning within the HRA does not persist agent-specific state and does not alter the agent substrate. All agent structure remains invariant across relational frames unless modified by systems external to the HRA.

### 6.2 Relationship to Epistemic Representations

The Human Relational Axes are independent of epistemic representation and interpretation.

They provide a relational framework within which epistemic content may be evaluated, without operating on that content directly.

The invention does not define epistemic meaning, belief states, or truth conditions.

6.2.1 Independence from Meaning and Interpretation

The HRA do not encode semantic content, epistemic stance, or interpretive judgment.

Relational structure is represented independently of what is said, believed, or asserted.

Identical epistemic content may traverse different relational channels and produce different lawful effects solely due to differences in relational configuration. The HRA represent these configurations without interpreting content or assigning evaluative weight.

6.2.2 Compatibility with Epistemic Determinate Expressions

The HRA are compatible with systems that produce resolved epistemic outputs, including Epistemic Determinate Expressions (EDEs). Such representations may be evaluated downstream within an HRA-defined relational frame to assess admissibility, relevance, or consequence.

The HRA do not modify, reclassify, or weight epistemic representations. They supply relational geometry only, enabling downstream systems to assess what epistemic content may lawfully do when situated between agents.

### 6.3 Relationship to Evaluation and Propagation Systems

The Human Relational Axes (HRA) define the relational context within which evaluation and propagation systems may operate, without performing evaluation, assigning salience, or determining outcome.

The invention supplies structural relational inputs that condition downstream processing, while remaining neutral with respect to judgment, relevance, and consequence.

### 6.3.1 Conditioning Without Evaluation

The HRA condition evaluation by defining which relational channels are structurally available for consideration. They specify where influence may originate, how it is directed, and which forms of relational force are admissible for assessment.

The HRA do not evaluate communicative acts, determine admissibility, or resolve propagation. They do not compute coercion, obligation, or consent. Instead, they establish the relational geometry within which such determinations may be made by downstream evaluative systems.

### 6.3.2 Deferral of Salience, Participation, and Consequence

All determinations of salience, participation, propagation, and consequence are explicitly deferred to systems external to the HRA. The existence of a relational channel does not imply that influence is admitted, weighted, or acted upon.

Downstream systems may consult the HRA to determine whether a given form of influence is structurally admissible, but the HRA do not assert that any influence should occur or that any outcome is required.

This deferral preserves neutrality and prevents evaluative logic from being embedded within relational representation.

### 6.4 Relationship to Temporal Architectures

The Human Relational Axes are independent of temporal architecture and do not define time, ordering, or progression. They represent relational positioning only, without encoding temporal dynamics.

### 6.4.1 No Temporal Authority or Ordering

The HRA do not advance time, assign temporal order, or establish present-state authority. They do not maintain timelines, histories, or temporal state.

Relational structure defined by the HRA remains invariant across temporal contexts unless explicitly re-evaluated relative to a different frame. Temporal progression is governed by systems external to the HRA.

6.4.2 Compatibility with External Time Systems

The HRA are compatible with external temporal systems that define ordering, duration, and progression. Such systems may reference HRA-defined relational structure when assessing admissibility or consequence across time.

The HRA do not consume, modify, or produce temporal representations. They provide a time-agnostic relational geometry that may be used consistently across temporal contexts without coupling relational structure to time authority.

### 7. Architectural Boundaries and Non-Claims

### 7.1 Excluded Domains

The present invention is directed to structural relational representation only. Certain domains are expressly excluded to preserve neutrality, modularity, and clear separation of concerns.

### 7.1.1 Psychological and Cognitive Modeling

The invention does not model psychological states, cognitive processes, beliefs, intentions, desires, preferences, emotions, or internal mental representations. Agents are not treated as belief-holders, decision-makers, or cognitive systems within the scope of the invention.

No inference regarding internal state is performed or implied by relational positioning within the Human Relational Axes. Any psychological or cognitive modeling must be implemented by systems external to the HRA framework.

### 7.1.2 Normative, Moral, or Policy Evaluation

The invention does not encode normative judgments, moral assessments, policy rules, or prescriptions regarding what actions should be taken. It does not determine correctness, legitimacy, fairness, or compliance.

Relational structure defined by the invention does not assert permission, obligation, entitlement, or prohibition. All normative and policy-based evaluation is deferred to downstream systems operating outside the HRA.

### 7.2 Non-Interpretive and Non-Computational Nature

The Human Relational Axes function as a representational framework, not as a computational or decision-making system.

### 7.2.1 No Inference or Resolution

The invention does not perform inference, resolution, classification, or interpretation of content. It does not infer intent, authority, relevance, or outcome from relational configuration. Assignment of entities to relational axes is structural and frame-relative, not inferential. The HRA do not resolve conflicts, arbitrate influence, or determine admissibility.

### Machine-Domain Non-Interference.

The Human Relational Axes are a structural representational framework only and do not participate in machine-side execution, legality determination, or state transition. Relational structure defined herein must not gate, constrain, or override agent-internal machines, coupling layers, or world-side authorities, including but not limited to relational state machines, policy interfaces, identity engines, encounter-gating mechanisms, canonical state authorities, or ordering substrates. Relational axes and channels are consumed strictly as read-only structural context by downstream systems that explicitly assume responsibility for interpretation, evaluation, participation, propagation, or consequence.

### 7.2.2 No State Mutation or History Storage

The invention does not mutate agent state, store historical records, or advance system state. It does not write, revise, or interpret history.

Relational frames defined by the HRA are non-persistent and exist only as contextual representations for evaluation. Persistence, history, and temporal inscription are handled by systems external to the HRA framework.

### 7.3 Evaluator Neutrality and Interchangeability

The invention does not restrict the evaluator position (“Self”) to any particular ontological category. The Self position is defined as a relational evaluation role within the HRA framework, not as a designation of species, embodiment, authority, or cognitive architecture.

Any registered agent capable of occupying a relational position may serve as the evaluator without modification to the relational framework. Occupying the Self position confers no epistemic privilege, authority, or entitlement beyond establishing the perspectival origin of evaluation.

Evaluator interchangeability is preserved across human, institutional, artificial, or other non-human agents, provided that relational admissibility constraints are satisfied. This neutrality ensures that the invention remains applicable to heterogeneous multi-agent environments while preserving lawful constraint, auditability, and separation between relational structure and evaluative outcome.

### Example Embodiments (Non-Limiting)

### 8.1 Human-Human Interaction

In one example embodiment, two agents are situated within a relational frame, with one agent designated as the Self and the other assigned to the Human Other axis. A communicative act originating from the Human Other is represented as exerting communicative force along a directional relational channel toward the Self.

The Human Relational Axes represent the presence and directionality of this relational channel without interpreting the content of the communication, assigning authority, or determining outcome. The relational framework distinguishes this interaction from non-agentic constraint and admits reciprocal relational channels without asserting consent, relevance, or consequence.

Downstream systems may evaluate the communicative act within this relational frame to assess admissibility, salience, or effect. The HRA themselves provide only the relational geometry within which such evaluation may occur.

### 8.2 Human—Nature Constraint

In another example embodiment, an agent designated as the Self is subject to influence arising from non-agentic conditions, such as environmental constraints, biological limitations, or institutional systems. These influences are represented within the relational frame as originating from the Nature axis and acting upon the Self.

The Human Relational Axes distinguish such non-subjective forces from communicative interaction with other agents. Assignment to the Nature axis asserts absence of subjectivity and consent, without implying inevitability, hostility, or normative significance.

This representation enables downstream systems to evaluate the effect of non-agentic constraint separately from interpersonal communication, while preserving a unified relational framework.

### 8.3 Observational Relational Forces

In a further example embodiment, the Self observes an interaction between two entities other than itself. The Self registers perceptive force arising from this observation, even though no direct communicative act is directed toward the Self.

Within the HRA framework, such influence is represented through observational relational channels. These channels capture the fact that indirect perception of interaction may exert influence without implying intent, address, or communicative targeting.

Observational relational forces are structurally distinct from direct interpersonal channels and from non-agentic constraint. They enable modeling of indirect influence while maintaining separation between observation, interpretation, and outcome.

### 8A. Supplemental Disclosure: HRA-Compatible Downstream Support Without Functional Absorption

### 8A.1 Priority-Core Preservation

The supplemental disclosure set forth in this section is additive to the Human Relational Axes framework described above. It does not replace, narrow, redefine, or condition the priority-core relational framework of the invention. The priority-core Human Relational Axes remain directed to a minimal relational-positioning substrate by which agents and non-agentic forces are situated relative to a designated evaluator through the relational axes of Self, Human Other, and Nature.

The supplemental material clarifies how the Human Relational Axes may be consumed by downstream architectures that perform later-developed functions such as admissibility mediation, communicative routing, dyadic interaction profiling, domain description, informational participation, agent-relative information transduction, evaluation, or action preparation. Such downstream architectures are invention-class distinct unless expressly claimed in a separate claim set. The Human Relational Axes remain a relational-positioning framework and do not acquire the authority, function, or scope of any downstream architecture merely because the downstream architecture may consume HRA outputs.

### 8A.1.1 Minimal HRA Relational-Positioning Core

The minimal HRA relational-positioning core consists of a relational frame, a designated evaluator occupying the Self position, relational positioning of other subjectivities through the Human Other axis, relational positioning of non-subjective force or constraint through the Nature axis, and directional relational channels through which communicative or perceptive force may be structurally considered.

This minimal core defines relational positioning only. It does not determine semantic meaning, communicative intent, subjective interiority, agent class, institutional status, access, encounter, transduction, representation, evaluation, participation, propagation, persistence, visibility, action preparation, action selection, or execution. It supplies a structural context in which influence may be situated relative to the evaluator without asserting what such influence means, whether such influence is accepted, whether such influence is understood, whether such influence matters, or what consequence follows.

The minimal HRA core therefore remains the foundational relational surface of the invention. Later-developed architectures may consume the core relational surface, but such consumption does not alter the core's authority or convert the core into the downstream architecture that consumes it.

### 8A.1.2 Supplemental Material as Non-Limiting Additive Disclosure

The supplemental material disclosed herein provides non-limiting support for later-compatible uses, integrations, and boundary-preserving extensions of the Human Relational Axes. The supplemental material is not required to practice the minimal HRA relational-positioning core unless expressly recited in a claim directed to such supplemental material.

The supplemental material may describe compatibility with downstream systems that evaluate communicative routing, structural admissibility, dyadic interaction-field availability, informational participation, entity-class stratification, agent-relative internal formation, or other later-developed components. Such description does not import those downstream components into the Human Relational Axes. It merely identifies how the HRA relational frame may supply read-only relational context to downstream systems while preserving one-way dependency and prohibiting feedback into the HRA structure.

Accordingly, any later-developed term, interface, profile, admissibility structure, interaction field, packet, domain surface, agent class, or downstream output described in this supplemental section shall be understood as optional, non-limiting, and invention-class distinct from the priority-core HRA framework unless separately and expressly claimed.

### 8A.1.3 No Redefinition of Original HRA Axes

The supplemental material does not redefine the original Human Relational Axes. The Self axis remains the evaluator-relative perspectival position. The Human Other axis remains the relational position corresponding to another subjectivity capable of reciprocal influence relative to the evaluator. The Nature axis remains the relational position corresponding to non-subjective force, constraint, condition, or influence.

Later-developed architectures may define higher-resolution seats, entity classes, dyadic profiles, interaction modes, institutional categories, artifact roles, continuation classes, or agent-stratification layers. Such refinements do not alter the minimal HRA axes. They may subdivide, elaborate, or consume HRA-compatible relational context for their own downstream purposes, but they do not retroactively modify the HRA axis definitions.

For example, a downstream system may distinguish among an institution, artifact, automated system, proxy structure, interaction entity, continuant, agent, or minded agent. Such distinctions are downstream classifications or profile refinements. They do not replace the HRA relational axes and do not cause the HRA framework itself to determine institutional subjectivity, entity class, continuation status, agenthood, mindedness, or communicative competence.

### 8A.2 HRA as Minimal Relational-Positioning Surface

The Human Relational Axes define a minimal relational-positioning surface. A relational-positioning surface is a structural surface that situates agents, entities, forces, or conditions relative to a designated evaluator without determining the downstream meaning, eligibility, consequence, or authority of the situated relation.

Within the present invention, the HRA relational-positioning surface serves as read-only relational context for downstream systems. It may identify where influence originates, how influence is directionally situated, and whether the influence is associated with Self, Human Other, or Nature relative to the evaluator. The HRA surface does not determine whether a signal is admitted, whether an event is instantiated, whether an interaction field is active, whether information becomes agent-relative, whether an entity is a continuant or agent, whether a downstream system should evaluate consequence, or whether any action should occur.

The HRA surface therefore preserves the distinction between relational positioning and downstream processing. It gives later systems a stable relational context, but it does not absorb the authority of those systems.

### 8A.2.1 Relational Frame as Positioning Surface

A relational frame under the HRA framework functions as a positioning surface rather than as an ontological, epistemic, evaluative, or executive surface. The relational frame identifies the evaluator-relative arrangement of relevant agents, entities, forces, or conditions within the relational geometry.

The relational frame is perspectival but non-privileged. It is perspectival because relational positioning is indexed relative to the entity designated as Self. It is non-privileged because designation as Self does not confer truth authority, evaluative authority, action authority, institutional authority, or epistemic superiority. The Self position establishes only the origin from which relational position and directionality are described.

The relational frame is also non-executory. The existence of a relational frame does not activate interaction, route a signal, create an event, propagate content, assign status, determine access, or produce a consequence. It defines a surface on which relational position can be inspected by downstream systems without causing downstream effects.

### 8A.2.2 Relational Triangle as Minimal Structural Substrate

The Relational Triangle remains the minimal structural substrate for representing the Human Relational Axes. The triangle provides a triadic arrangement of Self, Human Other, and Nature, allowing relational influence to be positioned relative to the evaluator without requiring a higher-resolution ontology.

The Relational Triangle is not a complete agent ontology, entity taxonomy, institutional model, domain-description framework, or interaction-field profile. It is a minimal relational scaffold. It is sufficient to distinguish evaluator-relative self-position, subject-to-subject relational positioning, and non-subjective force or constraint positioning.

Downstream systems may construct additional structures over or from the Relational Triangle, including higher-resolution seat ontologies, dyadic profiles, communicative routing determinations, domain relation-surfaces, or agent-relative participation structures. Such structures may use the Relational Triangle as an input or reference surface, but they do not become part of the minimal Relational Triangle unless expressly claimed as a supplemental embodiment.

### 8A.2.3 Directional Channels as Relational Context

Directional channels within the HRA framework provide relational context by specifying source-target orientation of communicative or perceptive force relative to the evaluator. A directional channel indicates that a form of influence may be structurally situated from one relational position toward another. The channel does not assert that influence has been activated, transmitted, encountered, understood, accepted, or acted upon.

Channel direction is therefore a contextual property, not an outcome property. It distinguishes the orientation of potential influence from the occurrence or effect of influence. A channel may exist without activation. A channel may be activated without encounter. Encounter may occur without transduction. Transduction may occur without representation. Representation may occur without belief, evaluation, or action.

The HRA directional channel therefore supplies a relational fact for downstream systems: the structural orientation of influence within the relational frame. It does not determine downstream routing, admissibility, propagation, uptake, evaluation, or execution.

### 8A.2.4 Communicative and Perceptive Force as Structural Availability

Communicative and perceptive force under the HRA framework refers to structural availability of influence, not to causal force, coercive force, social force, normative force, or executed effect. The HRA framework uses force language to identify the relational availability of influence relative to the evaluator.

Communicative force may be structurally associated with signals, utterances, gestures, inscriptions, actions, or other emitted structures. Perceptive force may be structurally associated with observed conditions, environmental states, non-agentic constraints, visible changes, bodily conditions, institutional conditions, or interactions among other entities. In each case, HRA represents the relational positioning of the force, not its interpretation or consequence.

Accordingly, communicative and perceptive force within HRA does not imply consent, comprehension, obligation, permission, legitimacy, authority, salience, participation, propagation, or action. It identifies where influence is structurally available for consideration by downstream systems and preserves the boundary between relational availability and downstream determination.

8A.3 Downstream Compatibility without Functional Absorption

The Human Relational Axes may be compatible with multiple downstream architectures, including but not limited to communicative routing systems, declarative admissibility systems, dyadic interaction profiling systems, informational participation systems, agent-relative information transduction systems, domain-description systems, evaluative systems, and action-preparation systems. Compatibility does not mean absorption.

A downstream system may consume HRA relational outputs as read-only context. Such consumption may condition downstream analysis under the downstream system's own authority. However, the downstream system's output does not retroactively alter HRA axis assignment, relational frame identity, channel existence, channel direction, or relational positioning.

This one-way dependency preserves the HRA framework as a stable relational-positioning surface. HRA may support downstream architectural development without becoming the downstream architecture and without allowing downstream artifacts to redefine the HRA substrate.

### 8A.3.1 HRA Outputs as Read-Only Relational Context

HRA outputs are read-only relational context. They may identify the evaluator, the relational axis associated with an entity or force, the directional channel through which influence is positioned, or the relational frame within which such positioning occurs. These outputs may be inspected, recorded, cited, visualized, or consumed by downstream systems.

Read-only consumption means that downstream systems may use HRA outputs as inputs, but may not modify those outputs by virtue of downstream use. Interpretation does not rewrite HRA. Evaluation does not rewrite HRA. Routing does not rewrite HRA. Admissibility does not rewrite HRA. Access, encounter, transduction, representation, packetization, domain projection, integration, visibility, persistence, action preparation, or execution does not rewrite HRA.

Any change to HRA inputs or outputs must occur through explicit re-declaration of the relational frame or its declared structural inputs. A downstream result may justify a separate external re-declaration procedure, but the downstream result itself does not feed back into HRA automatically.

8A.3.2 Downstream Consumption without HRA Expansion

A downstream architecture may consume HRA outputs without expanding the HRA framework. For example, a downstream admissibility system may inspect HRA channel direction. A dyadic interaction profiling system may inspect HRA relational positioning. An agent-relative information transduction system may inspect the relational source of encountered material. An evaluative system may inspect HRA geometry when contextualizing consequence. None of these uses expands HRA into admissibility, profiling, transduction, or evaluation.

The HRA framework remains limited to relational positioning. It does not acquire additional fields, outputs, or authorities merely because a downstream system requires more detailed computation. Downstream systems remain responsible for originating their own determinations, including admissibility states, interaction-field classes, access states, encounter states, transduction states, packet statuses, domain outputs, relevance candidates, evaluative observations, or action-preparation candidates.

Accordingly, downstream consumption is permitted only as consumption of relational context. It does not transform HRA into a multifunctional processing layer.

8A.3.3 No Downstream Function Imported into HRA

No downstream function is imported into the HRA framework by compatibility, integration, dependency, or consumption. HRA does not become a communicative routing system because routing systems consume HRA channel context. HRA does not become a declarative admissibility system because admissibility systems consume HRA relational outputs. HRA does not become a dyadic interaction profile because dyadic profiling systems consume HRA relational positioning. HRA does not become an agent-transduction system because agent-relative information systems consume HRA source or channel context.

Likewise, HRA does not become an informational ontology, domain-description architecture, entity-class stratification system, event primitive, communicative chain interface, evaluation layer, persistence system, visibility system, action-preparation system, or execution system merely because such systems may refer to HRA output.

This prohibition preserves invention-class distinctness. HRA supplies relational geometry. Downstream systems perform their own functions under their own authority. Functional compatibility does not collapse function boundaries.

### 8A.3.4 No Substitution of Downstream Artifacts for HRA Structure

Downstream artifacts may not substitute for HRA structure. An admissibility declaration, dyadic interaction profile, interaction-field activation, informational participation record, agent-concept packet, domain profile, evaluative observation, capability output, routing decision, visibility state, persistence record, or action-preparation candidate may be associated with an HRA relational frame, but it does not replace the HRA relational frame.

A downstream artifact may provide additional information about how a relationally situated structure is processed, accessed, encountered, profiled, evaluated, or acted upon. It does not redefine which entity occupies Self, Human Other, or Nature in the HRA frame. It does not alter the directional channel originally declared in HRA. It does not convert a non-activated channel into an activated event. It does not convert HRA relational availability into consent, comprehension, belief, obligation, or authority.

Substitution is prohibited because it would allow downstream processing to rewrite the relational substrate that made downstream processing possible. The HRA structure remains independently inspectable and prior to downstream artifacts that consume it.

### 8A.5 Communicative Routing Channel Compatibility

The Human Relational Axes may be used in connection with downstream communicative routing channel architectures. In such embodiments, HRA relational outputs may provide relational-positioning context for determining which communicative handling classes, routing channels, or interaction layers may later be structurally eligible for consideration. Such compatibility does not convert the HRA framework into a communicative routing system.

The HRA framework defines relational axes and directional relational channels. A downstream communicative routing channel system may consume those channel outputs when determining whether an update-like, communication-like, comprehension-like, or other communicative handling layer is structurally eligible. However, the HRA framework itself does not compute communicative-layer eligibility, does not route signals, does not activate channels, does not admit events, and does not determine whether any communicative act has occurred.

Accordingly, communicative routing channel compatibility means that HRA may supply relational geometry to downstream routing or admissibility systems while preserving strict separation between relational positioning and communicative routing authority.

### 8A.5.1 HRA Channel Outputs as Inputs to Downstream CRC Systems

In some embodiments, HRA directional channel outputs may be supplied as inputs to downstream Communicative Routing Channel systems or functionally equivalent routing-admissibility architectures. Such outputs may include the designated evaluator, the relational axis assignment of a source or target, the source-target orientation of a relational channel, and the relational frame within which the channel is defined.

A downstream CRC system may inspect these outputs to determine whether a particular class of communicative handling is structurally eligible under the downstream system's own rules. For example, a downstream CRC system may distinguish among update-only handling, addressed communication handling, comprehension-reliant handling, or other layer-specific modes of communicative force. Such distinctions are downstream determinations and are not produced by HRA itself.

The HRA channel output remains a relational-positioning artifact. It does not become a CRC output merely because a CRC system consumes it. The downstream CRC system must originate any routing-layer eligibility result under its own authority, with its own declared inputs, rules, and invariants.

### 8A.5.2 CRC Eligibility as Downstream Determination

CRC eligibility, where present, is a downstream determination. It is not inherent in the HRA relational frame and is not produced merely by the existence of an HRA channel.

An HRA channel may identify that influence is directionally situated from a source toward a target within a relational frame. A CRC system may later determine whether that channel supports a particular communicative layer, whether the signal is limited to update-like handling, whether addressed communication is structurally eligible, or whether comprehension-reliant handling is structurally supportable. Such CRC eligibility determinations depend on downstream structural inputs that are outside the authority of HRA.

The existence of an HRA directional channel therefore does not imply that any CRC layer is eligible. It does not imply that a signal is communicative, that a signal is addressed, that comprehension is possible, that a receiving entity is capable of uptake, or that any interaction class should be activated. CRC eligibility must remain a downstream output rather than an HRA property.

### 8A.5.3 No Routing Authority in HRA

The HRA framework possesses no routing authority. It does not route signals, select channels, activate communication, schedule delivery, determine propagation, establish encounterability, or transmit content.

HRA may identify a directional relational channel as part of relational positioning. That identification does not cause a signal to traverse the channel. It does not initiate a message. It does not deliver a communicative act. It does not make an entity encounter a signal. It does not cause a downstream system to process the signal. Routing authority, where present, belongs to downstream systems specifically configured to perform routing, propagation, accessibility, encounter, or delivery functions.

Accordingly, HRA channel representation must remain distinct from operational routing. A channel may be structurally represented without being used. A channel may be eligible for downstream inspection without being activated. A channel may provide context for routing without becoming the routing mechanism itself.

### 8A.5.4 No Communicative Layer Activation by HRA

The HRA framework does not activate communicative layers. It does not determine whether an Update field, Communication field, Comprehension field, or other communicative interaction layer is active in a given dyad or event.

HRA may provide relational context that a downstream architecture uses when evaluating communicative-layer availability. Such downstream evaluation may consider HRA axis placement, source—target directionality, or relational frame structure. However, the downstream architecture remains responsible for determining whether any communicative layer is available, active, suppressed, masked, attenuated, or otherwise conditioned.

HRA relational positioning therefore does not imply communicative activation. Non-agentic influence may be relationally situated without becoming communication. A communicative artifact may be relationally situated without being comprehended. A relational channel may exist without any update, communication, or comprehension field being active. Communicative-layer activation remains downstream and invention-class distinct from HRA.

### 8A.5.5 No Signal Admission or Event Instantiation by HRA

The HRA framework does not perform signal admission or event instantiation. It does not determine whether a carrier signal becomes an interaction event, communicative event, structural event primitive, or other event-level object within an interaction system.

A signal, utterance, gesture, inscription, environmental condition, machine output, institutional record, or other carrier artifact may be situated relationally by HRA if the relevant relational inputs are declared. Such relational positioning does not admit the carrier artifact into an interaction field. It does not create a General Interaction Event Primitive, Communicative Event Primitive, communicative chain object, canonical event, or downstream action candidate.

Signal admission and event instantiation require downstream admission, event-representation, or interaction-field systems operating under their own authority. HRA may supply relational context to such systems, but it does not perform the admission or instantiation functions itself.

### 8A.6 Declarative Admissibility Compatibility

The Human Relational Axes may be compatible with declarative admissibility architectures that determine whether a structure, channel, event, signal, agent relation, or interaction surface is eligible for downstream handling. Such compatibility does not convert HRA into an admissibility-normalization system.

HRA relational outputs may provide declared relational context to downstream eligibility or admissibility systems. Those downstream systems may determine whether the relationally situated structure is eligible for routing, encounter, participation, propagation, evaluation, visibility, persistence, or other downstream processing. The HRA framework does not make those determinations.

Accordingly, HRA may support admissibility analysis without itself becoming an admissibility layer. It supplies relational geometry, not eligibility authority.

### 8A.6.1 Eligibility Mediation as Downstream Use

Eligibility mediation is a downstream use of HRA outputs. A downstream eligibility system may inspect the relational frame, axis assignment, or directional channel produced by HRA to determine whether a structure is eligible for a particular downstream operation. Such operations may include interaction handling, communicative routing, participation review, propagation review, access review, encounter review, domain processing, evaluative inspection, or action-preparation review.

The HRA framework does not originate the eligibility decision. It does not normalize eligibility into a declarative admissibility structure. It does not determine whether a relation is permitted, whether a signal should be routed, whether an entity may participate, whether a structure should propagate, or whether a downstream system should process the structure.

Eligibility mediation remains governed by the downstream system that performs it. HRA supplies only relational context.

8A.6.2 HRA Relational Context without Admissibility Normalization

HRA relational context is not admissibility normalization. Relational context indicates how agents, entities, forces, or conditions are positioned relative to a designated evaluator. Admissibility normalization, by contrast, determines whether a structure is lawfully eligible for downstream interaction under declared eligibility rules.

These functions must remain separate. A directional HRA channel may be available as relational context without being admissible for any particular downstream operation. A structure may be situated as Human Other or Nature without being eligible for propagation, evaluation, routing, participation, visibility, persistence, or action preparation. A relational frame may be defined without producing any downstream admissibility state.

If a downstream system produces an admissibility declaration using HRA context, that declaration remains a downstream artifact. It does not retroactively become part of the HRA relational frame and does not alter the HRA axis assignment or channel structure.

8A.6.3 Eligibility without Participation

Even where a downstream system determines that a relationally situated structure is eligible for some downstream operation, eligibility does not imply participation. Eligibility indicates that a structure may be lawfully available for downstream consideration under the downstream system's rules. It does not imply that the structure participates, propagates, is perceived, is evaluated, is adopted, is internalized, is persisted, is made visible, or is acted upon.

This distinction is especially important where HRA outputs are used by admissibility or participation systems. HRA may indicate a relational channel. A downstream system may declare the channel eligible for inspection or handling. Neither condition establishes that participation occurs. Participation, where present, requires additional downstream processing under a system that possesses participation authority.

Thus, the chain remains separated: relational positioning is not eligibility, eligibility is not participation, and participation is not consequence.

8A.6.4 Admissibility without Authority Transfer

Admissibility determinations based on HRA relational context do not transfer authority to HRA. Conversely, HRA relational outputs do not transfer authority to admissibility systems beyond the downstream authority those systems independently possess.

A downstream admissibility system may declare eligibility, but such declaration does not assign truth, belief, comprehension, consent, obligation, evaluation, execution, or canonical world-state authority. The HRA framework may supply relational context, but such context does not grant the downstream system permission to rewrite HRA, infer subjectivity, assign agent class, or determine outcome.

Admissibility therefore remains bounded. It mediates eligibility for downstream use without converting relational context into authority and without converting downstream eligibility into HRA structure.

### 8A.7 Dyadic Interaction Field Compatibility

The Human Relational Axes may be compatible with downstream dyadic interaction field profiling systems. Such systems may construct profiles describing how one entity becomes interactionally available relative to another entity within a progression medium. HRA may provide relational-positioning inputs to such profiles, including evaluator-relative axis placement and directional channel context.

However, HRA does not itself construct dyadic interaction profiles. It does not determine continuation organization, interaction-field class, interactional legibility origin, accessibility-conditioned activation, progression-relative evolution, masking, attenuation, or mediated interaction routing. Those determinations belong to downstream dyadic profiling architectures. Accordingly, HRA may support dyadic interaction field profiling without being absorbed into it. HRA supplies minimal relational geometry; dyadic profiling produces richer progression-relative interaction descriptions.

### 8A.7.1 HRA Relational Positioning as Dyadic Profile Input

In some embodiments, HRA relational positioning may serve as an input to a downstream dyadic profile. The downstream profile may identify a first entity, a second entity, and the relational orientation between them. HRA may contribute evaluator-relative placement and directionality for that relation.

Such input may help a dyadic profiling system determine how the second entity is situated relative to the first entity, whether the relation involves subject-to-subject positioning, non-subjective constraint, observational influence, or other relational context. However, these downstream profile determinations are not HRA determinations unless expressly claimed as part of a supplemental embodiment.

The HRA input remains limited to relational positioning. The dyadic profile may add continuation, interaction, accessibility, legibility, or progression-relative structure under its own authority.

### 8A.7.2 Interaction Field Availability as Downstream Profile Output

Interaction field availability is a downstream profile output. A dyadic profiling system may determine whether an Update field, Communication field, Comprehension field, or other interaction field is available, active, inactive, masked, attenuated, or suppressed in a particular dyad.

HRA does not determine those fields. An HRA channel may provide context for the dyadic system, but it does not establish that an Update field is active, that Communication is occurring, or that Comprehension is structurally available. Those outputs require additional downstream structural analysis beyond the minimal HRA relational frame.

Interaction field availability therefore remains distinct from HRA channel existence. A relational channel can exist without any interaction field being active. An interaction field can be profiled only by a downstream architecture configured to perform that profiling function.

### 8A.7.3 Update, Communication, and Comprehension Fields as Downstream Classes

Update, Communication, and Comprehension fields are downstream interaction classes, not original HRA axes. The HRA axes remain Self, Human Other, and Nature. The downstream fields describe classes of interactional availability or participation that may be determined by dyadic profiling systems or other interaction architectures.

An Update field may involve non-addressive or environmental structural influence. A Communication field may involve stance-bearing or addressed interaction. A Comprehension field may involve recursive role-aware relational participation or comprehension-reliant interaction structure. These distinctions may be useful to downstream systems, but they are not required to define the minimal HRA relational-positioning core.

The HRA framework therefore remains compatible with these fields while remaining independent of them. The downstream fields may consume HRA relational context, but they do not redefine the HRA axes.

### 8A.7.4 Interactional Legibility Origin as Downstream Determination

Interactional legibility origin is a downstream determination. A dyadic profiling system may determine whether interactionally legible structure arises intrinsically from the profiled entity, extrinsically through another entity's inscription or modification, through environmental residue, through artifact mediation, through institutional routing, through scientific reconstruction, or through mixed-origin structures.

HRA does not determine legibility origin. The HRA framework may situate a sign, environmental trace, institutional output, gesture, utterance, or non-agentic condition within a relational frame. It does not determine whether the structure's legibility is intrinsic, extrinsic, deposited, mediated, reconstructed, intentional, environmental, or mixed.

Legibility-origin analysis remains downstream. It may rely on HRA relational context, but it must be generated by a system configured to perform interactional legibility or dyadic profile analysis.

### 8A.7.5 Progression-Relative Interaction Evolution Outside HRA

Progression-relative interaction evolution occurs outside HRA. A downstream dyadic profiling architecture may determine that interactional availability changes over progression due to accessibility changes, masking, attenuation, new observations, mediated reconstruction, environmental alteration, field overlays, or changes in downstream interaction conditions.

The HRA framework does not evolve relational structure through progression by itself. It does not accumulate interaction history, update channels through repeated exposure, escalate force over time, soften constraints through familiarity, or infer new relational structure from downstream events. Any change to HRA relational inputs requires explicit re-declaration.

A downstream dyadic profile may evolve while the HRA relational frame remains unchanged. Conversely, an HRA frame may be re-declared while a downstream dyadic profile preserves prior state under its own rules. These are distinct architectural operations, and neither operation automatically rewrites the other.

### 8A.8 Informational Participation Compatibility

The Human Relational Axes may be compatible with downstream informational participation architectures that distinguish structural information, perturbational influence, communicative artifacts, recursive relational participation, and recursive epistemic modeling. Such compatibility does not convert HRA into an informational ontology.

The HRA framework may situate informationally relevant structures within a relational frame. For example, a non-agentic condition may be positioned through the Nature axis, an utterance or gesture from another subjectivity may be positioned through the Human Other axis, and self-originating perception or reflection may be positioned through the Self axis. Such positioning does not determine whether the structure is merely perturbational, communicative, recursively relational, epistemically modeled, or agent-internally represented.

Accordingly, HRA supports informational participation analysis by supplying relational context. It does not define informational existence, structural transduction, communicative artifact formation, continuation-relative informational relevance, or recursive epistemic participation.

### 8A.8.1 Information Prior to Communication

The HRA framework is compatible with architectures in which information exists prior to communication. Informationally relevant structure may arise from environmental perturbation, biological change, physical constraint, computational state, institutional record, bodily condition, or other structural differentiation without becoming a communicative act.

HRA may position such information relative to the evaluator. For example, the information may be situated as arising from Nature, from Human Other, or from Self-relative perception. However, HRA does not determine the informational ontology of the structure. It does not determine whether the structure is a perturbation, representation, communicative artifact, recursive participation object, or epistemic model.

This preserves the distinction between relational positioning and informational classification. A structure may be informationally consequential before it is communicative, and HRA may situate its relational source or force without converting it into communication.

8A.8.2 Perturbational Influence without Communicative Status

The HRA framework permits non-agentic or non-addressive influence to be relationally situated without assigning communicative status. A virus, storm, obstruction, heat gradient, biological condition, computer failure, institutional constraint, or environmental trace may affect a continuation-bearing system without communicating to that system.

Such influence may be represented within HRA as perceptive force, non-agentic constraint, or Nature-positioned force relative to the evaluator. That representation does not imply that the influence is a message, utterance, signal of intent, warning, request, or stance-bearing communication.

Downstream systems may later interpret, reconstruct, model, or evaluate the perturbational influence. For example, an agent may infer a hidden cause, form a hypothesis, or evaluate continuation consequence. Those downstream operations do not retroactively convert the original perturbational influence into communication at the HRA layer.

8A.8.3 Environmental Legibility without Agentive Signaling

Environmental structures may become legible to an evaluator without being agentive signals. Tracks, clouds, symptoms, traces, residues, damage patterns, noise, heat, smoke, system logs, or other environmental structures may support downstream reconstruction or interpretation while lacking intentional address or subjective emission.

HRA may situate such environmental legibility within the relational frame. It may represent the source of influence as non-subjective, observational, or Nature-positioned relative to the evaluator. However, HRA does not determine that the legible structure is communicative, intentional, agent-authored, or addressed.

This distinction allows downstream architectures to model environmental extraction, reconstruction, or informational relevance without anthropomorphizing the source. Legibility is not signaling. Extractability is not communication. Relational positioning is not agentive attribution.

### 8A.8.4 Communicative Artifacts as Downstream Informational Structures

A communicative artifact may be relationally situated by HRA without HRA determining its full informational status. A written sign, utterance, gesture, message, symbol, interface output, institutional notice, or machine-generated textual artifact may be positioned relative to Self, Human Other, or Nature depending on the declared relational frame and source-context inputs.

However, classification of the artifact as communicative, transmissible, recursive, symbolic, epistemic, institutional, agent-originated, proxy-mediated, or artifact-carried is a downstream determination. HRA does not determine the artifact's provenance, communicative force class, chain dependency, semantic content, source authority, interpretive completeness, or epistemic status.

The HRA framework may therefore provide relational source and channel context for downstream informational systems while preserving the distinction between relational positioning and communicative artifact analysis.

### 8A.8.5 Recursive Informational Participation Outside HRA

Recursive informational participation occurs outside the HRA framework. A downstream system may model recursive relational participation, role-aware communication, recursive epistemic modeling, counterfactual informational structures, abstract representational recursion, or higher-order meaning formation. Such systems may consume HRA relational context, but they do not become part of HRA.

HRA does not recursively model how agents interpret each other, does not represent another agent's internal informational topology, and does not determine whether a communicative act participates in recursive recognition, comprehension, abstraction, or epistemic modeling. It supplies only the relational frame within which such downstream recursive informational processes may later be analyzed.

Accordingly, recursive informational participation may be HRA-compatible while remaining invention-class distinct and downstream.

### 8A.9 Agent-Relative Information Transduction Compatibility

The Human Relational Axes may be compatible with downstream agent-relative information transduction architectures. Such architectures may govern how substrate structure, accessed structure, encountered structure, transduced input, modelable structure, basis-coordinate material, payloads, packets, or other internal information structures become agent-relative inside a bounded agent or agent-equivalent system.

HRA does not perform that formation process. HRA may identify relational context associated with a source, signal, condition, or force. It may situate an influence relative to Self, Human Other, or Nature. It may identify a directional channel. But HRA does not determine whether the influence becomes accessible, encountered, transduced, represented, packetized, believed, evaluated, persisted, visible, actionable, or acted upon.

Accordingly, HRA may support agent-relative information transduction as upstream relational context, but it does not become an agent-internal formation trunk or downstream participation architecture.

8A.9.1 HRA Positioning without Agent Access Determination

HRA positioning does not determine agent access. A structure may be relationally positioned relative to an evaluator without being accessible to the evaluator. A source may be located in Human Other or Nature, and a directional channel may be declared, while the relevant signal, object, condition, or information remains inaccessible, hidden, obstructed, unavailable, permission-bound, tool-dependent, or otherwise outside the evaluator's access surface.

The HRA framework therefore does not infer access from relational position. Relational position identifies where influence is situated if and when the relevant relational structure is declared. It does not determine that the evaluator can see, hear, inspect, query, receive, or otherwise access the situated structure.

Access remains a downstream or adjacent authority. If a downstream access system uses HRA relational context, its access result does not alter the HRA relational frame.

### 8A.9.2 Access, Encounter, and Transduction Outside HRA

Access, encounter, and transduction are outside HRA. Access concerns lawful availability. Encounter concerns actual presentation or contact. Transduction concerns conversion into handled input. These functions require systems or surfaces beyond the HRA relational-positioning framework.

An HRA channel may exist without access. Access may exist without encounter. Encounter may occur without transduction. Transduction may occur partially, ambiguously, incorrectly, or not at all. HRA does not collapse these stages into one another.

Accordingly, an utterance, signal, condition, object, trace, institutional record, artifact, or environmental perturbation may be relationally situated by HRA while remaining unaccessed, unencountered, or untransduced by the evaluator. HRA relational positioning supplies no default awareness, perception, comprehension, or internal handling.

### 8A.9.3 Representation, Payload Formation, and Packet Sealing Outside HRA

Representation, payload formation, and packet sealing are outside HRA. A structure may be accessed, encountered, or transduced without becoming represented as an internal object. A represented candidate may form without becoming a status-bearing packet. A packet may be sealed without becoming truth, belief, evaluation, persistence, visibility, actionability, or action.

HRA does not determine any of these agent-internal transitions. It does not form candidate internal content. It does not compose agent-concept payloads. It does not seal packets. It does not assign provenance, certainty posture, realis posture, access basis, mediation depth, source trace, or downstream status.

If a downstream agent-relative information architecture uses HRA to identify the relational source or directional context of a payload or packet, such use remains downstream. The payload or packet does not redefine HRA, and HRA does not originate the payload or packet status.

### 8A.9.4 Packet Routing and Receiving-Substrate Authority Outside HRA

Packet routing and receiving-substrate authority are outside HRA. A downstream agent-internal system may route a sealed packet, provisional packet-equivalent structure, domain output, annotation, or other content-bearing internal structure to a receiving substrate. That routing does not originate from HRA merely because the routed content contains HRA-derived relational context.

HRA does not decide where packets go, whether receiving substrates admit them, whether domains process them, whether lifecycle systems update them, whether visibility systems expose them, whether persistence systems store them, whether evaluative systems evaluate them, or whether action-preparation systems use them.

A receiving substrate may consume HRA-derived context as part of its own processing. Such consumption does not grant the receiving substrate authority to modify HRA axis assignment, channel direction, channel existence, or relational frame structure. Routing is downstream carriage, not HRA modification.

8A.9.5 Agent-Internal Participation without HRA Feedback

Agent-internal participation may occur without feedback into HRA. A relationally situated structure may later become accessible, encountered, transduced, represented, packetized, routed, projected into a domain, integrated, evaluated, persisted, made visible, recursively modeled, or used in action preparation. Those downstream stages may produce agent-internal effects under their own authority.

None of those effects retroactively modifies HRA. Agent-internal belief does not rewrite HRA. Domain output does not rewrite HRA. Evaluation does not rewrite HRA. Persistence does not rewrite HRA. Visibility does not rewrite HRA. Action preparation or execution does not rewrite HRA.

If a later system determines that the relational frame should be updated, such update must occur through explicit re-declaration of HRA inputs. HRA does not update itself from downstream agent-internal participation.

### 8A.10 Entity-Class and Relational Mode Orthogonality

The HRA framework is compatible with entity-class stratification and relational-mode stratification, but it does not perform either classification. HRA axis placement identifies how an entity, force, or condition is positioned relative to a designated evaluator. Entity-class stratification determines what kind of internal continuation-bearing organization an entity possesses. Relational-mode stratification determines what kind of interaction field is available in a dyad or context. These are distinct surfaces.

HRA therefore preserves orthogonality between axis placement, entity class, and relational mode. A structure may be placed within the HRA frame without determining whether it is an interaction entity, continuant, agent, or minded agent. A structure may participate in update-like, communication-like, or comprehension-like relations without that participation determining its HRA axis placement or entity class.

This orthogonality prevents relational positioning from becoming agent ontology and prevents communicative appearance from becoming proof of subjectivity or mindedness.

8A.10.1 HRA Axis Placement without Entity-Class Assignment

HRA axis placement is not entity-class assignment. Placement relative to Self, Human Other, or Nature establishes relational position within a specific frame. It does not determine whether the positioned structure possesses persistence-conditioned continuation organization, self-localization, introspective accessibility, recursive representational capacity, institutional form, artifact status, proxy status, or minded-agent status.

The Human Other axis may identify a subjectivity-facing relational position where the declared frame treats another entity as a subjective counterparty. This does not cause HRA to determine the full internal entity class of that counterparty. The Nature axis may identify a non-subjective constraint or force relative to the evaluator. This does not cause HRA to classify every Nature-positioned structure as a particular kind of entity, artifact, institution, or environmental system. Entity-class assignment, where needed, is performed by a downstream or adjacent stratification architecture operating under its own criteria.

### 8A.10.2 Interaction Entity, Continuant, Agent, and Minded Agent Outside HRA

Interaction Entity, Continuant, Agent, and Minded Agent classifications are outside HRA. Such classifications concern internal organizational depth, continuation-bearing persistence, self-localization, introspective accessibility, or recursive abstract representational compositionality.

The HRA framework does not determine those thresholds. It does not decide that a structure is merely an interaction entity. It does not decide that a structure is a continuant. It does not decide that a continuant is an agent. It does not decide that an agent is a minded agent.

A downstream entity-class stratification system may use HRA relational positioning as contextual information, but the class determination belongs to the downstream system. Conversely, an entity-class determination may inform later re-declaration of a relational frame, but it does not automatically rewrite HRA.

8A.10.3 Relational Mode Availability without Entity-Class Elevation

Relational mode availability does not elevate entity class. A structure may participate in or mediate an Update field, Communication field, Comprehension field, or other relational mode without thereby becoming a continuant, agent, or minded agent.

For example, an artifact may carry communicative structure without becoming the communicator. A sign may mediate communication without becoming an agent. An automated system may produce communication-like outputs without becoming a minded agent. An institution may route or mediate role-governed communication without acquiring unified subjectivity through the routing operation itself.

HRA remains compatible with downstream relational-mode systems while preserving the rule that relational mode participation is not entity-class assignment.

8A.10.4 Communication-Like Mediation without Agenthood

Communication-like mediation does not imply agenthood. A carrier, artifact, institution, interface, record, sign, automated message, or proxy structure may mediate communication-like content while lacking the internal organization required for agent classification.

The HRA framework may situate such a mediator within the relational frame. It may treat the structure as a source of perceptive force, as a carrier of another's communicative force, as a non-subjective condition, or as part of a declared relational channel depending on the inputs supplied. But HRA does not determine that the mediator is an agent merely because communication-like content is associated with it.

This preserves the distinction between communication as carried, communication as originated, and communication as internally agentive. Downstream systems may analyze provenance, inscription, proxy relation, or communicative origination. HRA does not resolve those questions.

8A.10.5 Comprehension-Like Participation without Mindedness Assignment

Comprehension-like participation does not imply mindedness assignment. A system, artifact, institution, proxy, or automated interface may participate in exchanges that appear explanatory, responsive, role-aware, conversational, or comprehension-like without thereby satisfying the internal structural threshold for minded-agent classification.

The HRA framework does not assign mindedness from such participation. It does not infer recursive abstract representational compositionality, semantic interiority, consciousness, self-awareness, or subjective comprehension from response, fluency, role participation, institutional function, or apparent understanding.

A downstream system may classify comprehension-field availability, role-aware interaction, or recursive participation under its own criteria. Such classification remains separate from HRA and does not modify HRA axis placement unless an explicit relational-frame re-declaration occurs.

### 8A.11 Institution, Artifact, Proxy, and Non-Subjective System Compatibility

The Human Relational Axes are compatible with later architectures that distinguish institutions, artifacts, proxies, automated systems, artificial systems, and other non-subjective or partially mediated structures. Such compatibility does not require the HRA framework to resolve the full ontology, subjectivity, agency, or internal organization of such structures.

The minimal HRA framework may situate non-subjective structures through the Nature axis where they function as non-subjective force, constraint, condition, artifact, carrier, interface, or environmental influence relative to the evaluator. Later systems may subdivide such structures into higher-resolution categories, including institutional systems, objective systems, artifact carriers, proxy structures, automated systems, interaction entities, continuants, agents, or minded agents. Such downstream subdivision does not redefine the original HRA axes.

Accordingly, HRA remains a relational-positioning framework. It supports downstream refinement of institutional, artifact, proxy, and non-subjective system handling without performing that refinement itself.

### 8A.11.1 Minimal HRA Treatment of Non-Subjective Structures

Under the minimal HRA framework, non-subjective structures may be situated as sources or carriers of force without being treated as subjectivities. Such structures may include environmental conditions, physical objects, biological conditions, institutional records, automated outputs, artifacts, signs, interfaces, system states, procedural structures, or other non-subjective sources of constraint or influence.

The Nature axis may be used to position such structures where the declared frame treats them as non-subjective relative to the evaluator. This positioning does not require HRA to determine the internal ontology of the structure. It does not determine whether the structure is an institution, artifact, proxy, automated system, continuant, agent, or other entity class.

Minimal HRA treatment therefore preserves non-subjective relational availability without resolving downstream classification. A non-subjective structure may be relationally present, perceptively influential, or informationally relevant without being treated as a communicating subject.

### 8A.11.2 Higher-Resolution Seat Ontologies as Downstream Refinements

Higher-resolution seat ontologies may be constructed downstream of HRA. Such ontologies may distinguish among subjective counterparties, institutional systems, artificial systems, automated processes, artifacts, communicative carriers, proxy actors, environmental constraints, biological processes, computational systems, and other relation-bearing structures.

Such refinements are compatible with HRA but are not required to practice the minimal HRA core. The original HRA axes remain Self, Human Other, and Nature. A higher-resolution downstream system may subdivide a Nature-positioned or Human-Other-positioned structure for its own purposes, but such subdivision does not alter the minimal HRA relational frame unless an explicit re-declaration of HRA inputs occurs.

Accordingly, higher-resolution seat ontologies are downstream refinements. They may consume HRA relational positioning as input, but they do not replace HRA axis definitions and do not retroactively modify HRA outputs.

### 8A.11.3 Institutional Routing Without Unified Subjectivity Determination

Institutional routing does not require unified subjectivity determination by HRA. An institution, office, workflow, role-bearing system, record system, automated agency, organizational process, or distributed procedural structure may route signals, issue notices, process records, or mediate communication without HRA determining that the institution possesses a unified subjective interior.

The HRA framework may situate institutional outputs, institutional constraints, institutional records, or institutional contact surfaces within a relational frame. Such positioning does not determine whether the institution is a Human Other, a Nature-positioned constraint, a proxy, a distributed objective system, an agent-equivalent system, or a higher-resolution institutional seat under another architecture.

Any determination that an institutional structure acts as a subjective counterparty, proxy, non-subjective objective system, communicative mediator, or authority-bearing structure is downstream or externally declared. HRA itself does not infer unified subjectivity from institutional routing, responsiveness, persistence, formality, legal status, or procedural behavior.

### 8A.11.4 Artificial or Automated System Participation Without Subjectivity Inference

Artificial or automated system participation does not imply subjectivity within HRA. An artificial system, automated process, machine agent, software service, model output system, robotic controller, interface, simulation component, or distributed computational process may produce outputs, respond to inputs, route information, mediate interaction, or appear conversational without HRA inferring subjective interiority.

The HRA framework may represent the artificial or automated system as relationally situated where declared inputs require such positioning. It may support downstream systems that later classify the system under higher-resolution entity or seat taxonomies. However, HRA does not determine belief, comprehension, consent, intention, self-localization, agenthood, or mindedness from responsiveness, fluency, interaction history, technical sophistication, or apparent autonomy.

Artificial or automated participation therefore remains compatible with HRA without collapsing into subjectivity. Any elevation of such a system into a subjective counterparty or agent class must occur through explicit downstream or external authority, not through HRA inference.

8A.11.5 Artifact-Mediated Communication without Artifact Agenthood

An artifact may mediate communication without becoming an agent. A sign, written document, inscription, recorded message, stored file, interface display, symbolic marker, instrument reading, institutional notice, transmitted packet, or other artifact may carry or preserve communicative structure originating from another source.

HRA may situate such an artifact as a source of perceptive force, as a carrier of communicative structure, as a Nature-positioned condition, or as part of a declared relational channel. Such positioning does not make the artifact a communicating subject, agent, continuant, minded agent, or unified institutional actor.

Downstream systems may analyze source, authorship, inscription, mediation, provenance, communicative artifact status, or proxy relation. HRA does not perform those analyses. It preserves the relational availability of the artifact without converting artifact-mediated communication into artifact agenthood.

### 8A.12 Channel Existence, Activation, and Non-Activation

The Human Relational Axes distinguish channel existence, channel activation, encounter, transduction, interpretation, and outcome. These stages must remain structurally separate.

A channel may exist as part of HRA relational geometry without being activated. A channel may be activated by a signal, condition, utterance, observation, gesture, artifact, or event without being encountered by the evaluator. An encountered structure may fail to be transduced. A transduced structure may fail to become represented, believed, evaluated, persisted, made visible, or acted upon.

The HRA framework therefore preserves channel existence as relational availability only. It does not treat channel existence as evidence of communication, encounter, uptake, or effect, and it does not treat non-activation as refusal, consent, avoidance, non-compliance, or downstream meaning.

### 8A.12.1 Channel Existence as Structural Availability

Channel existence means that a directional relational pathway is structurally available within a declared HRA frame. It indicates that influence may be positioned from a source toward a target relative to the evaluator.

Channel existence does not mean that a signal has been emitted, transmitted, received, encountered, transduced, interpreted, understood, accepted, or acted upon. It also does not mean that the channel is preferred, permitted, required, authoritative, or active.

Channel existence is therefore a relational-positioning condition. It supplies structural availability of directional influence, not operational use of that influence.

### 8A.12.2 Channel Activation as Separate Event

Channel activation is separate from channel existence. A channel may be activated when an utterance, signal, action, observation, artifact, environmental condition, or other force-bearing structure traverses or is situated along a channel.

Activation does not create the channel. It uses or occupies a channel already represented within the relational frame. Conversely, channel existence does not require activation. A channel may remain dormant indefinitely without producing consequence.

Channel activation, where represented, is not performed by HRA unless expressly claimed as part of a supplemental embodiment. Activation may be detected, admitted, or instantiated by downstream event, signal, routing, or interaction systems. HRA supplies only the relational channel context.

8A.12.3 Activation without Encounter

Channel activation does not imply encounter. A signal, event, artifact, or condition may be activated along a relational channel without being actually encountered by the evaluator or target.

For example, a communicative act may be emitted but not received. An environmental condition may exist but not be noticed. An institutional record may be generated but not opened. A signal may traverse a system boundary but not be presented to the relevant receiving surface.

HRA does not collapse activation into encounter. Encounter requires a downstream access, exposure, presentation, receipt, or contact condition. A downstream encounter result may consume HRA channel context, but it does not retroactively define the HRA channel.

8A.12.4 Encounter without Transduction

Encounter does not imply transduction. A structure may be encountered, contacted, presented, received, opened, observed, or exposed without being converted into a handled internal form.

A foreign-language utterance may be heard without being lexically decoded. A sign may be seen without being read. A symptom may be experienced without being diagnostically modeled. A log file may be opened without being parsed. A signal may reach a sensor without being converted above threshold.

HRA does not determine transduction. It does not infer that a target has converted encountered structure into usable input. Transduction remains downstream or adjacent to the HRA relational frame.

8A.12.5 Non-Activation without Refusal or Consent Inference

Non-activation of a channel carries no implied meaning. A channel that exists but is not activated must not be interpreted as refusal, consent, avoidance, acquiescence, non-compliance, lack of interest, lack of capacity, or absence of relationship.

Similarly, a lack of response along a channel does not imply agreement, disagreement, comprehension, misunderstanding, acceptance, rejection, obligation, or waiver. Non-activation is a structural non-event unless another system explicitly declares additional status under its own authority.

The HRA framework preserves non-activation as silence. Silence within the channel surface remains local and must not be promoted into global relational, epistemic, evaluative, or normative conclusion.

8A.12.6 Dormancy without Escalation or Decay

A dormant channel does not escalate or decay merely by remaining unused. The HRA framework does not strengthen, weaken, soften, attenuate, normalize, or intensify a relational channel based on duration of dormancy, frequency of non-use, repeated exposure, familiarity, or time elapsed.

Dormancy therefore remains structurally neutral. A dormant channel is not failed, abandoned, rejected, consented to, expired, accumulated, or intensified unless an external system explicitly re-declares the relational frame or a downstream system records a separate status under its own authority.

This preserves HRA as a static relational-positioning surface unless explicit re-declaration occurs.

### 8A.13 Time-Orthogonality of HRA Relational Positioning

The Human Relational Axes are time-orthogonal. The HRA framework may be applied at different moments, progression states, scenes, or contexts, but it does not itself compute temporal accumulation, persistence, escalation, decay, duration, sequence, urgency, or momentum.

Time-orthogonality means that relational positioning is not modified by time passage alone. A channel does not become more forceful because it has existed longer. A relation does not become more reciprocal because repeated interactions occurred. A non-response does not become refusal through duration. A downstream temporal system may evaluate temporal consequence, but such evaluation does not feed back into HRA unless the HRA frame is explicitly re-declared.

Accordingly, HRA relational positioning remains distinct from temporal reasoning, historical storage, progression modeling, persistence, and time-indexed evaluation.

### 8A.13.1 No Temporal Accumulation

The HRA framework does not accumulate relational force over time. It does not sum interactions, count exposures, weight duration, compute frequency, or convert repeated contact into increased force, increased authority, increased obligation, or increased relational standing.

Temporal accumulation, where relevant, must be computed by downstream temporal, evaluative, historical, persistence, or interaction-profile systems. Such systems may consume HRA context, but their accumulated outputs do not modify HRA automatically.

A relational channel therefore remains a declared channel, not an accumulating pressure field.

### 8A.13.2 No Interaction-History-Based Escalation

Interaction history does not escalate HRA relational status. Repeated signaling, repeated non-response, repeated proximity, repeated observation, recurring institutional contact, or recurring artificial-system output does not cause HRA to infer stronger relation, increased reciprocity, enhanced subjectivity, greater authority, deeper comprehension, implied consent, or higher obligation.

History may be relevant to downstream systems that explicitly track history, persistence, evaluation, or dyadic interaction evolution. HRA does not perform that tracking. It remains a relational-positioning surface evaluated from declared inputs.

Any change to HRA relation based on historical structure must be made through explicit re-declaration, not through automatic HRA adaptation.

### 8A.13.3 No Familiarity-Based Softening

Familiarity does not soften HRA constraints. A system must not relax asymmetry, infer reciprocity, infer consent, infer comprehension, infer authority, or reclassify non-subjective structures based on repeated interaction, social familiarity, technical familiarity, procedural familiarity, institutional familiarity, or apparent smoothness of exchange.

The HRA framework therefore resists normalization. Repeated exposure to a channel does not convert the channel into permission. Repeated output from an automated system does not convert the system into a subjectivity. Repeated reading of an artifact does not make the artifact an agent. Repeated compliance does not imply consent at the HRA layer.

Familiarity may be relevant downstream only where a downstream system has explicit authority to model it. It does not feed back into HRA.

### 8A.13.4 Time-Indexed Traits as External Inputs Only

Time-indexed traits may be used in connection with HRA only as externally declared inputs. A relational frame may be re-declared at a later time using changed circumstances, new entity classifications, updated access conditions, changed social context, modified institutional status, or other explicitly supplied time-indexed information.

However, HRA does not generate such time-indexed traits itself. It does not infer trajectory traits from duration, repetition, sequence, or historical interaction. It does not compute persistence, decay, maturation, escalation, or expiration.

Where time-indexed traits are supplied, HRA may consume them only as declared structural inputs to a new or updated relational frame. The source and authority of the trait remain external to HRA.

### 8A.13.5 Temporal Reasoning as Downstream Processing

Temporal reasoning is downstream processing. Systems that model ordering, persistence, historical encounter, temporal accessibility, time-indexed consequence, irrealis futures, forecasts, duration, recurrence, or progression-relative interaction evolution operate outside the HRA relational-positioning framework.

Such systems may consume HRA outputs as relational context. They may determine that a relationally situated structure has temporal consequence, historical relevance, persistence significance, or future-facing effect. Those determinations do not retroactively modify HRA. HRA therefore remains compatible with temporal systems while retaining no temporal authority. It does not advance time, store history, compute duration, project futures, evaluate persistence, or determine temporal consequence.

### 8B. Structural Invariants of Supplemental HRA-Compatible Architecture

### 8B. Structural Invariants of Supplemental HRA-Compatible Architecture

The supplemental HRA-compatible architecture is governed by structural invariants that preserve the Human Relational Axes as a minimal relational-positioning surface while allowing downstream systems to consume HRA outputs without functional absorption, authority transfer, or feedback. These invariants define the lawful behavior of HRA-compatible downstream use.

The invariants disclosed in this section are additive to the priority-core HRA framework. They clarify how later-developed systems may rely on HRA relational context while preserving the original HRA authority boundary.

### 8B.1 Minimal Relational Surface Invariant

The Human Relational Axes define a minimal relational surface. The HRA framework represents evaluator-relative relational positioning through the axes of Self, Human Other, and Nature, together with directional relational channels through which communicative or perceptive force may be structurally situated.

The HRA minimal relational surface does not include downstream admissibility, routing, interaction profiling, informational ontology, entity-class stratification, agent-relative transduction, evaluation, persistence, visibility, or action systems. Such systems may consume HRA outputs, but they are not part of the minimal HRA surface unless expressly claimed as separate supplemental embodiments.

This invariant preserves the HRA framework as a bounded relational-positioning substrate rather than a general-purpose interaction architecture.

### 8B.2 Read-Only Relational Context Invariant

HRA outputs are read-only relational context. A downstream system may inspect, record, display, reference, or consume HRA outputs, but such consumption does not authorize the downstream system to modify HRA axis assignments, relational-frame structure, channel existence, or channel direction.

Read-only relational context may include the identity of the designated evaluator, the relational position of another entity or force, the axis assignment of the entity or force, and the directionality of a relational channel. These outputs may inform downstream systems without becoming writable surfaces for those systems.

This invariant ensures that HRA remains structurally stable under downstream use.

### 8B.3 One-Way Dependency Invariant

Dependency between HRA and downstream systems is one-way. HRA outputs may flow downstream as relational-positioning context. Downstream outputs may not flow upstream to revise, complete, normalize, symmetrize, temporalize, or reinterpret HRA structure.

A downstream system may produce admissibility declarations, interaction profiles, access states, transduction results, packet structures, domain outputs, evaluative observations, or action-preparation candidates. Such outputs do not become upstream HRA inputs unless an explicit re-declaration process supplies them as new declared structural inputs.

This invariant preserves direction of constraint flow from HRA to downstream consumers and prohibits automatic back-propagation.

### 8B.4 No Feedback Invariant

No downstream feedback may modify HRA. Interpretation, evaluation, routing, admissibility, participation, propagation, access, encounter, transduction, representation, packetization, domain projection, integration, visibility, persistence, action preparation, action selection, or execution must not feed back into HRA by default.

A downstream system's conclusion that a structure was relevant, irrelevant, accessible, inaccessible, understood, misunderstood, believed, rejected, acted upon, ignored, persisted, or evaluated does not alter the HRA relational frame that supplied the original relational context. This invariant blocks downstream authority leakage and preserves the HRA layer as non-adaptive and non-impositive.

### 8B.5 Explicit Re-Declaration Invariant

Any change to HRA inputs or HRA relational structure requires explicit re-declaration. Re-declaration may occur when an external authority, configuration mechanism, scene registration process, or system layer authorized to define relational inputs supplies a new relational frame, new evaluator, new axis assignment, new channel declaration, or new channel direction.

A downstream output may be considered by an external re-declaration process, but the downstream output itself does not automatically become a new HRA state. HRA does not self-update from downstream effects, histories, or interpretations.

This invariant allows lawful update of HRA when necessary while preserving the prohibition on implicit feedback.

8B.6 Channel Existence and Activation Separation Invariant Channel existence and channel activation are structurally separate. A directional channel may exist in an HRA relational frame without being activated by any signal, utterance, observation, condition, artifact, event, or downstream process.

Activation, where represented, is a separate event or downstream condition. It does not create the channel, and the channel does not imply activation. HRA may represent channel existence as structural availability while leaving activation to downstream signal, event, admission, routing, or interaction systems.

This invariant prevents relational possibility from being mistaken for occurrence.

### 8B.7 Non-Activation Neutrality Invariant

Non-activation of an HRA channel is neutral. A channel that exists but is not activated must not be interpreted as refusal, consent, acquiescence, avoidance, non-compliance, lack of interest, lack of relationship, lack of capacity, or downstream meaning.

Similarly, absence of response along a channel must not be interpreted by HRA as agreement, disagreement, comprehension, misunderstanding, acceptance, rejection, obligation, waiver, or relational change.

This invariant preserves non-activation as local silence rather than global conclusion.

### 8B.8 Informational Participation Separation Invariant

Informational participation and HRA relational positioning are separate. A structure may be informationally relevant, perturbationally influential, environmentally legible, communicatively transmitted, recursively modeled, or epistemically abstracted without HRA determining its informational class.

HRA may situate the source, force, or relational orientation of informationally relevant structure, but it does not define informational ontology, structural transduction, communicative artifact formation, continuation-relative informational relevance, or recursive epistemic participation.

This invariant preserves compatibility with informational participation systems while preventing HRA from becoming an informational ontology.

### 8B.9 Communication Non-Primacy Invariant

Communication is not treated as the primitive form of all relational influence within HRA. Non-agentic, perturbational, environmental, biological, computational, institutional, or physical influence may be relationally situated without being classified as communication.

HRA may position communicative force and perceptive force, but the existence of relational influence does not imply a communicative act. A structure may affect an evaluator without addressing the evaluator. A structure may be legible without signaling. A structure may be informative without communicating.

This invariant prevents collapse of perturbation, legibility, influence, and communication into one undifferentiated relational category.

### 8B.10 Entity-Class Orthogonality Invariant

HRA axis placement is orthogonal to entity-class stratification. Placement within Self, Human Other, or Nature does not determine whether a structure is an interaction entity, continuant, agent, minded agent, institution, artifact, proxy, automated system, or other entity class.

Entity-class determinations require downstream or adjacent entity-stratification systems operating under their own thresholds. HRA may provide relational context to such systems, but it does not assign internal organizational class.

This invariant prevents relational position from becoming agent ontology.

### 8B.11 Relational Mode Orthogonality Invariant

HRA axis placement is orthogonal to relational mode availability. A downstream system may classify a relation as Update, Communication, Comprehension, or another interaction mode, but such classification is not inherent in the HRA axis assignment or channel declaration. A structure may be positioned in HRA without any downstream relational mode being active.

Conversely, a downstream relational mode may be profiled using HRA context without redefining the HRA axes.

This invariant prevents interaction-field classification from being imported into HRA.

### 8B.12 Higher-Resolution Compatibility Invariant

Higher-resolution seat ontologies, entity taxonomies, interaction profiles, or institutional classifications may refine HRA-compatible relational context downstream without replacing the minimal HRA axes. Such systems may distinguish institutional systems, artificial systems, artifacts, proxies, objective systems, continuants, agents, and minded agents.

Such refinement does not redefine Self, Human Other, or Nature in the minimal HRA core. It may operate as a downstream elaboration or separately claimed supplemental architecture while preserving HRA as the upstream relational-positioning surface. This invariant allows later precision without retroactive alteration.

### 8B.13 Institution Non-Resolution Invariant

HRA does not resolve institutional ontology. An institution may be relationally situated without HRA determining whether it is a unified subjectivity, distributed objective system, proxy, artifact-mediated system, role-bearing system, authority-bearing system, automated process, or agent-equivalent structure.

Institutional outputs, notices, actions, records, or procedures may be represented as relationally relevant without HRA inferring institutional belief, intent, comprehension, consent, or subjective interiority.

This invariant preserves institutional compatibility while avoiding conflict with downstream ARCH, agent, or entity-stratification systems.

### 8B.14 No Subjectivity Inference Invariant

Subjectivity is not inferred by HRA from behavior, responsiveness, communication-like output, institutional form, technical sophistication, repeated interaction, role status, fluency, apparent autonomy, or downstream utility.

HRA may position a declared subjectivity through the Human Other axis where the relational frame supplies that classification. However, HRA does not generate subjectivity classification from interaction patterns or downstream results.

This invariant prevents anthropomorphic collapse and preserves subjectivity determinations as externally declared or downstream-classified matters.

### 8B.15 Non-Authority Invariant

HRA outputs carry no authority to decide, permit, prohibit, obligate, validate, evaluate, execute, canonicalize, persist, expose, route, admit, or propagate. They do not assign truth, belief, consent, comprehension, legitimacy, entitlement, responsibility, standing, or outcome.

HRA supplies relational context only. Any downstream authority must originate in a downstream system that explicitly possesses that authority and must not be attributed to HRA merely because HRA context was consumed.

This invariant preserves HRA as a non-authoritative substrate.

### 8B.16 No Semantic Input Invariant

HRA relational positioning does not depend on semantic interpretation. HRA does not parse meaning, infer intent, analyze propositional content, resolve speech acts, evaluate rhetoric, classify truth, or interpret communicative substance.

Axis assignment and channel declaration must arise from declared structural inputs, not from semantic inference. Downstream semantic systems may consume HRA context, but semantic output may not feed back into HRA by default.

This invariant preserves HRA as pre-interpretive.

### 8B.17 No Evaluative Input Invariant

HRA relational positioning does not depend on evaluative judgment. It does not consume salience, importance, risk, harm, benefit, utility, priority, alignment, policy, preference, or consequence scores as native HRA inputs.

A downstream evaluative system may inspect HRA structure. However, evaluation may not modify HRA axis assignment, channel direction, or relational frame structure. HRA must not become more or less active, forceful, authoritative, or symmetric because downstream evaluation judged a relation important or unimportant.

This invariant prevents evaluation from becoming upstream relational authority.

### 8B.18 Determinism and Inspectability Invariant

HRA outputs must be deterministic and inspectable with respect to declared HRA inputs. Given the same evaluator designation, axis assignments, channel declarations, and relational-frame inputs, HRA produces the same relational-positioning outputs.

HRA must not rely on hidden arbitration, adaptive weighting, learned authority, stochastic inference, semantic interpolation, or evaluative negotiation. Outputs must be traceable to declared inputs and auditable without reconstructing hidden downstream reasoning.

This invariant supports reproducibility and auditability of the relational-positioning surface.

### 8B.19 Local Silence Preservation Invariant

Silence within the HRA surface remains local. Absence of a declared channel does not imply global absence of relationship. Absence of activation does not imply refusal or consent. Absence of Human Other classification does not imply nonexistence of a subjectivity outside the declared frame. Absence of HRA-recognized communication does not imply absence of informational participation.

Local silence must not be promoted into global negation, downstream exclusion, institutional denial, entity-class denial, access denial, or evaluative conclusion without a separate authority-bearing system.

This invariant preserves incompleteness without false closure.

### 8B.20 Downstream Independence Invariant

Downstream architectures remain independent of HRA even when they consume HRA context. A downstream system may perform admissibility normalization, communicative routing, dyadic profiling, informational participation analysis, domain description, agent-relative transduction, entity-class stratification, evaluation, persistence review, visibility review, action preparation, or execution under its own authority.

HRA does not control those systems, and those systems do not control HRA. The relationship is one of bounded compatibility and read-only consumption, not merger, substitution, or shared authority.

This invariant preserves the non-collapse architecture across HRA and its downstream consumers.

### 8C. Prohibited Operations and Non-Claims

This section defines prohibited operations and non-claims for the supplemental HRA-compatible architecture. These prohibitions preserve invention-class distinctness, prevent adjacent-layer collapse, and ensure that the Human Relational Axes remain a minimal relational-positioning framework rather than a downstream processing architecture.

The prohibitions in this section are structural scope boundaries. They do not deny that downstream systems may consume HRA outputs. They establish that such downstream systems remain invention-class distinct and that their functions are not imported into HRA merely by compatibility, dependency, or use.

### 8C.1 Prohibited Redefinition of the Priority Core

The supplemental material must not redefine the priority-core Human Relational Axes. The original relational-positioning core remains defined by the evaluator-relative axes of Self, Human Other, and Nature, together with relational frames, directional channels, and communicative or perceptive force as structural availability.

No supplemental section, downstream compatibility statement, invariant, example, or later-developed interface may convert the original HRA framework into a different axis system, a higher-resolution seat ontology, an agent ontology, a communicative routing architecture, an admissibility normalization system, a dyadic profile, an informational ontology, an evaluation system, or an action architecture.

The supplemental material may describe later-compatible downstream use. It may not alter the minimum HRA core required to practice the original relational-positioning invention.

### 8C.2 No Agent Ontology Definition

The HRA framework does not define a complete agent ontology. It does not determine what constitutes an agent, non-agent, continuant, minded agent, artificial agent, institutional agent, proxy, artifact, or entity class.

The Self, Human Other, and Nature axes are relational positions within an evaluator-relative frame. They are not a complete ontology of entities. Axis placement does not determine the internal organization, persistence, agency, cognition, selfhood, subjectivity, mindedness, institutional status, biological status, artificial-system status, or legal status of the positioned structure.

Any agent ontology, if present, belongs to a downstream or adjacent architecture with its own authority, definitions, and thresholds.

### 8C.3 No Entity-Class Stratification

The HRA framework does not perform entity-class stratification. It does not assign a structure to classes such as interaction entity, continuant, agent, minded agent, artifact, proxy, institutional system, automated process, or non-agentic condition.

Entity-class stratification concerns internal organizational depth, continuation-bearing structure, self-localization, introspective accessibility, recursive representational capacity, or other criteria outside the HRA relational-positioning surface. HRA may provide relational context to a downstream entity-classification system, but it does not originate the classification.

Accordingly, HRA axis placement must not be treated as entity-class assignment.

### 8C.4 No Continuant, Agent, or Minded-Agent Classification

The HRA framework does not classify a structure as a continuant, agent, or minded agent. It does not determine whether an entity possesses persistence-conditioned continuation-sensitive organization, bounded self-localization, introspective accessibility, or recursive abstract representational compositionality.

A structure may be relationally positioned within HRA without satisfying any continuant, agent, or minded-agent threshold. Conversely, a structure may satisfy a downstream continuant, agent, or minded-agent threshold without HRA itself making that determination.

Any such classification must be performed by a separate entity-class stratification architecture or external declaration authority. HRA remains limited to relational positioning.

### 8C.5 No Institutional Subjectivity Determination

The HRA framework does not determine whether an institution possesses unified subjectivity. An institution, organization, agency, office, procedural system, role-bearing structure, record system, corporate entity, governmental body, workflow, distributed process, or other institutional structure may be relationally situated by HRA without HRA resolving whether the institution is a subjectivity, objective system, proxy, artifact, agent-equivalent system, or authority-bearing entity.

HRA does not infer institutional subjectivity from institutional output, official status, legal recognition, responsiveness, procedural behavior, authority claims, communication routing, record generation, or repeated interaction.

Institutional subjectivity or non-subjectivity, where relevant, must be determined by a downstream seat ontology, entity-class stratification architecture, legal/institutional authority, or other external system. HRA does not resolve that issue.

### 8C.6 No Artificial-System Subjectivity Determination

The HRA framework does not determine whether an artificial, automated, robotic, software, model-based, simulated, distributed, or hybrid system possesses subjectivity.

HRA does not infer subjectivity from fluency, responsiveness, adaptive behavior, apparent autonomy, role performance, conversational form, simulated empathy, task competence, recursive output, self-description, or interaction history. Such features may be relevant to downstream classification systems, but they do not become HRA determinations.

An artificial or automated system may be relationally situated within HRA under declared inputs. That relational positioning does not classify the system as subjective, non-subjective, agentic, minded, or conscious.

### 8C.7 No Communicative Routing Channel Definition

The HRA framework does not define a Communicative Routing Channel system. It does not determine update-layer eligibility, communication-layer eligibility, comprehension-layer eligibility, routing admissibility, highest admissible communicative layer, downward forcing, or communication-channel activation rules.

HRA may supply directional channel context to a downstream CRC or functionally equivalent system. However, the CRC system must originate its own eligibility outputs, routing determinations, communicative-layer classifications, and admissibility decisions under its own authority.

Compatibility with CRC does not transform HRA into CRC.

### 8C.8 No Declarative Admissibility Normalization

The HRA framework does not perform Declarative Admissibility Normalization. It does not normalize lawful eligibility into admissibility structures, eligibility membranes, eligibility declarations, admissibility records, or downstream eligibility artifacts.

HRA relational positioning does not determine whether a structure is eligible for routing, access, encounter, participation, propagation, visibility, persistence, domain projection, evaluation, action preparation, or execution. Such determinations require downstream admissibility systems with separate authority.

HRA outputs may be consumed as context by admissibility systems, but they do not themselves constitute admissibility declarations.

### 8C.9 No Dyadic Interaction Field Profiling

The HRA framework does not construct Dyadic Continuation-Interaction Profiles or functionally equivalent dyadic interaction field profiles. It does not determine continuation organization, progression interaction modality, relational interaction field class, interactional legibility origin, accessibility-conditioned activation, masking, attenuation, suppression, or progression-relative interaction evolution.

HRA may provide relational-positioning context to a dyadic profiling system. The dyadic profile system remains responsible for its own profile coordinates and outputs. HRA does not become a dyadic profile merely because a dyadic profile consumes HRA context.

Accordingly, HRA relational positioning must remain distinct from dyadic interaction field profiling.

### 8C.10 No Interaction Admission

The HRA framework does not perform interaction admission. It does not determine whether a carrier signal, utterance, message, gesture, machine output, environmental trace, institutional record, or other carrier artifact becomes an interaction event.

HRA does not evaluate structural signal validity, carrier admissibility, interaction eligibility, capability compatibility, authorization conditions, or admission state. It does not admit, reject, defer, queue, or conditionally admit signals into an interaction system.

Interaction admission, where present, belongs to a distinct admission architecture. HRA may provide relational context to such an architecture but does not perform the admission function.

### 8C.11 No General Interaction Event Primitive Formation

The HRA framework does not form a General Interaction Event Primitive or any equivalent interaction event primitive. It does not bind a signal carrier reference, structured model representation, and interaction configuration parameters into an event object. It does not instantiate an emitted occurrence as a structural event within an interaction field.

A downstream event primitive system may consume HRA-derived relational context, including source-target orientation or relational axis position. Such consumption does not make HRA the event primitive formation layer.

HRA remains prior relational context, not event representation.

### 8C.12 No Communicative Chain Interface Resolution

The HRA framework does not perform Communicative Chain Interface resolution. It does not determine whether one communicative event satisfies another, whether a dependency is resolved, whether an utterance answers a question, whether an action fulfills a request, or whether a fragment completes a prior event.

HRA also does not assign dependency emission markers, dependency compatibility markers, discourse roles, chain attachments, or event-to-event resolution states unless expressly claimed in a separate supplemental embodiment.

A downstream communicative chain interface may use HRA context when analyzing event relationships, but HRA does not resolve communicative chains.

### 8C.13 No Domain Description Architecture

The HRA framework does not define a stratified domain description architecture. It does not describe domains through domain-intrinsic properties, entity-domain coupling properties, and entity-internal access, control, and modeling properties.

HRA does not determine what a domain is, how an entity is coupled to the domain, how the entity accesses the domain, how the entity models the domain, or how cross-group mediation occurs. HRA may situate a domain-related force within a relational frame, but it does not produce a domain profile.

Domain description architectures may consume HRA outputs as relational context. Their domain-profile outputs do not redefine HRA.

### 8C.14 No Agent-Relative Information Transduction

The HRA framework does not perform agent-relative information transduction. It does not determine substrate structure, access, encounter, transduction, modelability, basis-coordinate availability, payload formation, packet sealing, downstream eligibility, domain projection, routing, lifecycle governance, integration, visibility, persistence, evaluation, action preparation, action selection, or execution.

HRA may position the relational source or direction of an influence that later becomes part of an agent-relative information formation process. However, the formation process itself is downstream and invention-class distinct.

Accordingly, HRA does not convert relationally situated influence into agent-internal information.

### 8C.15 No Informational Ontology Definition

The HRA framework does not define informational ontology. It does not determine what information is, whether structural differentiation is informationally admissible, whether a perturbation becomes structural representation, whether an informational object is formed, whether a communicative artifact exists, whether informational provenance is preserved, or whether continuation-relative informational relevance arises.

HRA may situate informationally relevant force or influence within a relational frame. It does not determine the informational layer, informational status, informational admissibility, structural transduction, communicative artifact formation, recursive relational participation, or recursive epistemic modeling of that influence.

Informational ontology remains a downstream or adjacent architecture. HRA remains relational positioning.

### 8C.16 No Access, Encounter, or Transduction Determination

The HRA framework does not determine access, encounter, or transduction. Relational positioning does not establish that an evaluator can access a structure, that a structure has been encountered, or that an encountered structure has been converted into handled input.

A source, force, channel, artifact, condition, or signal may be situated within an HRA relational frame while remaining inaccessible, unencountered, untransduced, partially transduced, degraded, ambiguous, or unavailable to the evaluator. HRA does not infer perception, receipt, contact, availability, sensory conversion, parsing, decoding, or internal handling from relational position.

Access, encounter, and transduction require downstream or adjacent systems with their own authority. Such systems may consume HRA context, but their outputs do not alter HRA by default.

### 8C.17 No Representation, Payload, or Packet Formation

The HRA framework does not form representations, payloads, packets, packet-equivalent structures, or agent-internal information objects. It does not compose candidate internal content, generate Agent-Concept Payloads, assign packet headers, seal Agent-Concept Packets, mark provisional packet-equivalent structures, or create status-bearing internal units.

A relationally situated structure may later become represented, payloaded, packetized, or routed within an agent-relative architecture. Such downstream formation does not originate from HRA. HRA may supply relational source or channel context, but it does not determine the content, status, provenance, certainty, realis posture, access basis, mediation depth, or downstream eligibility of any internal packet.

Accordingly, HRA remains external relational context rather than agent-internal representational formation.

### 8C.18 No Belief, Truth, or Knowledge Assignment

The HRA framework does not assign belief, truth, knowledge, certainty, correctness, validation, domain conclusion, epistemic commitment, or canonical fact status. A structure may be positioned relative to Self, Human Other, or Nature without HRA determining whether the structure is believed, known, true, false, validated, suspected, hypothetical, remembered, reported, or rejected.

HRA also does not determine whether any agent understands, accepts, adopts, endorses, or internally carries the content of a signal or condition. Such determinations belong to downstream epistemic, agent-relative, domain-specific, or evaluative systems.

The HRA relational frame therefore supplies context for possible downstream epistemic processing without becoming an epistemic authority.

### 8C.19 No Evaluation, Ranking, or Optimization

The HRA framework does not evaluate, rank, score, prioritize, optimize, recommend, compare by desirability, compute salience, determine relevance, assign risk, calculate benefit, or select preferred outcomes.

Relational positioning does not determine whether an influence is important, harmful, helpful, coercive, safe, unsafe, aligned, misaligned, valuable, irrelevant, urgent, or action-worthy. It also does not determine which relational channel, force, or situated structure should receive priority.

Any downstream evaluation, ranking, optimization, or prioritization must occur in an invention-class distinct system with explicit evaluative authority. HRA may be consumed as relational context by such a system, but HRA itself remains non-evaluative.

### 8C.20 No Persistence, Visibility, or Internal Registration

The HRA framework does not determine persistence, visibility, internal registration, memory, archival status, lifecycle status, display state, exposure state, or continued availability. It does not decide whether a relationally situated structure is stored, remembered, persisted, exposed, hidden, made visible, registered, archived, deleted, attenuated, or reactivated.

An HRA relational frame may be recorded as an artifact of analysis or system operation, but such recording is not an HRA determination of persistence authority. Similarly, HRA may identify relational position without causing the positioned structure to become visible or internally registered in any agent-relative system.

Persistence, visibility, and internal registration remain downstream or adjacent authority surfaces.

### 8C.21 No Action Preparation, Selection, or Execution

The HRA framework does not prepare, select, authorize, execute, block, compel, or recommend action. It does not produce action candidates, operator selections, control signals, behavioral plans, execution commands, workflow triggers, or policy interventions.

Relational positioning may contextualize where influence is situated, but it does not determine what should be done in response. A signal from a Human Other, a constraint from Nature, or a self-relative condition may later be considered by an action-preparation or execution system.

Such consideration remains downstream and does not convert HRA into an action system.

HRA therefore preserves the distinction between relational context and behavioral consequence.

### 8C.22 No Consent, Comprehension, or Uptake Inference

The HRA framework does not infer consent, comprehension, uptake, awareness, agreement, acceptance, endorsement, refusal, acknowledgment, or understanding. Such states must not be inferred from channel existence, channel activation, encounter, response, silence, non-response, repetition, institutional form, artificial-system output, artifact mediation, or apparent conversational structure.

A relational channel may exist without consent. A signal may be transmitted without uptake. An utterance may be encountered without comprehension. A response may occur without agreement. Silence may occur without refusal or acceptance.

Any determination of consent, comprehension, or uptake must occur outside HRA under explicit authority. HRA supplies no default internal-state inference.

### 8C.23 No Permission, Obligation, Entitlement, or Authority Assignment

The HRA framework does not assign permission, obligation, entitlement, legitimacy, standing, status, responsibility, authority, or right. The existence of a relational channel does not permit action. The presence of communicative or perceptive force does not impose obligation.

Placement on a relational axis does not confer entitlement, rank, priority, or legitimacy.

HRA does not determine whether one entity may command another, whether a receiver must respond, whether a signal is authorized, whether a relationship is legitimate, or whether any actor bears responsibility.

Normative, legal, institutional, policy, or authority-bearing determinations require external systems or downstream architectures with explicit authority. HRA does not supply such authority.

### 8C.24 No Routing, Transmission, Propagation, or Event Admission

The HRA framework does not route, transmit, propagate, broadcast, deliver, suppress, filter, queue, admit, reject, defer, or instantiate signals or events. It does not cause a carrier signal to become an interaction event, communicative event, propagation object, routed packet, or execution candidate.

A relational channel is not a transmission channel. A directional relation is not signal delivery. Relational availability is not propagation. HRA may provide context for systems that route or admit signals, but it does not perform routing or admission itself.

Accordingly, no routing, transmission, propagation, or event-admission authority is claimed by HRA.

### 8C.25 No Canonical Existence or World-State Authority

The HRA framework does not determine canonical existence, world-state authority, canonical progression, system state, historical truth, timeline status, event reality, or authoritative record status.

A structure may be relationally positioned without HRA determining whether the structure canonically exists. HRA does not create or modify canonical records, advance canonical state, resolve world-state conflicts, determine what occurred, or govern persistence of world history. Canonical existence and world-state authority belong to distinct systems. HRA may consume declared entities or forces already supplied by such systems, but it does not create or validate them.

### 8C.26 No Learning, Adaptation, or Normalization

The HRA framework does not learn, adapt, tune, normalize, recalibrate, soften, harden, optimize, or update its relational geometry based on downstream results, behavior, repetition, familiarity, success, failure, usage, training, or environmental response.

HRA outputs are determined from declared relational inputs. They are not generated from learned patterns, statistical inference, reinforcement, behavioral adaptation, or outcome-driven normalization.

Any modification of HRA inputs requires explicit re-declaration. HRA does not self-modify by exposure, use, history, or downstream performance.

### 8C.27 No Symmetrization or Reciprocity Inference

The HRA framework does not infer symmetry or reciprocity from a directional channel. A channel from one relational position toward another does not imply a reverse channel. A communicative act from one entity toward another does not imply mutuality, shared standing, shared context, reciprocal access, reciprocal obligation, or reciprocal consent.

Reciprocity, where relevant, must be explicitly declared or determined by a downstream system with appropriate authority. Repeated interaction, response, proximity, role relation, institutional relation, or apparent dialogue does not cause HRA to infer bidirectionality.

This prohibition preserves directionality as a structural feature rather than a social or behavioral inference.

### 8C.28 No Temporalization, Accumulation, or Escalation

The HRA framework does not temporalize relational positioning. It does not accumulate force, escalate channels, decay relations, compute duration, store history, assign momentum, infer trajectory, or increase authority through repetition or persistence.

A channel does not become stronger because it has existed longer. A non-response does not become refusal through time. A repeated signal does not become more authoritative within HRA. Familiarity does not soften constraints.

Temporal analysis, historical modeling, progression-relative interaction evolution, and persistence evaluation are downstream functions. HRA remains time-orthogonal unless explicitly re-declared with new structural inputs.

### 8C.29 No Downstream Feedback Into HRA Structure

No downstream system may feed back into HRA structure by default. Downstream systems include, without limitation, access systems, encounter systems, transduction systems, representation systems, packet systems, domain systems, routing systems, admissibility systems, dyadic profile systems, evaluation systems, persistence systems, visibility systems, action-preparation systems, execution systems, learning systems, and canonical state systems.

Outputs from such systems may be inspected externally, but they do not modify HRA axis assignment, channel existence, channel direction, evaluator designation, or relational frame structure unless an explicit re-declaration process occurs.

This prohibition is central to the supplemental HRA-compatible architecture. HRA may support downstream systems, but downstream systems do not rewrite HRA.

### 8C.30 No Collapse of Perturbation, Communication, and Comprehension

The HRA framework does not collapse perturbation, communication, and comprehension into a single category. A perturbational influence may affect an evaluator without communicating. A communicative artifact may transmit structure without being comprehended. A comprehension-like interaction may occur downstream without proving subjectivity, mindedness, belief, or uptake at the HRA layer.

HRA may situate each of these forms of influence relationally, but it does not reduce them to one another. Environmental perturbation, communicative transmission, and recursive comprehension remain distinct downstream or adjacent regimes.

This prohibition preserves the layered architecture in which information may precede communication, communication may precede comprehension, and comprehension may precede recursive epistemic participation.

### 8D. Supplemental Architectural Effect

The supplemental HRA-compatible architecture produces a bounded architectural effect: it allows the Human Relational Axes to support later-developed downstream systems while preserving HRA as a minimal, read-only, non-authoritative relational-positioning surface. The effect is not the creation of a new agent ontology, admissibility system, communicative routing system, dyadic profile, informational ontology, agent-relative information-transduction trunk, evaluative layer, or execution architecture. The effect is the preservation of HRA relational geometry as stable upstream context that may be consumed by such systems without being absorbed, rewritten, or authority-converted by them.

Accordingly, the supplemental architecture clarifies how HRA participates in a broader non-collapse stack: HRA supplies relational positioning; downstream systems may perform their own functions; and no downstream function becomes HRA merely by consuming HRA context.

### 8D.1 Relational Positioning Without Downstream Authority

The first architectural effect is relational positioning without downstream authority. The HRA framework may situate agents, entities, forces, artifacts, conditions, or non-subjective structures relative to a designated evaluator without determining what downstream systems must do with that relational positioning.

HRA can identify that a source or influence is situated as Self, Human Other, or Nature relative to the evaluator, and can identify a directional relational channel within that frame. That relational positioning does not assign downstream eligibility, admission, participation, propagation, access, encounter, transduction, representation, packetization, evaluation, persistence, visibility, action preparation, action selection, execution, or world-state authority. This effect allows downstream systems to receive relational context without HRA becoming a command surface. HRA explains where influence is situated; it does not decide what follows from that influence.

### 8D.2 Downstream Support Without Functional Absorption

The second architectural effect is downstream support without functional absorption. The HRA framework may support later-developed architectures by supplying relational context, but it does not absorb the functions of those architectures.

A communicative routing system may consume HRA channel direction. A declarative admissibility system may consume HRA relational context. A dyadic interaction profiling system may consume HRA positioning. An agent-relative information transduction system may consume HRA source-context information. An entity-class system may consume HRA relational information while applying independent classification thresholds. An evaluative system may consume HRA context when observing consequence.

In each case, the downstream system performs its own function under its own authority. HRA is not expanded into that downstream function merely because it is useful to that function. This preserves invention-class distinctness and prevents layer collapse by recomposition.

### 8D.3 Read-Only Relational Context Across Heterogeneous Architectures

The third architectural effect is read-only relational context across heterogeneous architectures. HRA outputs may be consumed by symbolic systems, graph systems, rule-based systems, simulation systems, agent architectures, interaction-field systems, domain-description systems, informational participation systems, evaluative systems, institutional systems, artificial-agent systems, or hybrid computational architectures.

Across these heterogeneous embodiments, the HRA output remains the same kind of object: relational-positioning context. It may be stored, displayed, referenced, inspected, routed as metadata, associated with an event, associated with a packet, associated with a domain profile, or consumed by a downstream system. However, such heterogeneous use does not convert HRA into the storage system, event system, packet system, profile system, or evaluation system that consumes it.

This effect makes HRA portable across architectures while preserving its limited authority. HRA remains context, not control.

### 8D.4 Non-Feedback Preservation of HRA Relational Geometry

The fourth architectural effect is non-feedback preservation of HRA relational geometry. Once HRA relational geometry has been declared, downstream use of that geometry does not modify it.

A downstream system may determine that a relation is admissible, inadmissible, active, inactive, accessible, inaccessible, transduced, untransduced, represented, unrepresented, evaluated, ignored, believed, rejected, visible, persistent, actionable, or acted upon. None of those results retroactively changes the original HRA axis assignment, channel direction, channel existence, evaluator designation, or relational frame.

This effect preserves the auditability of the relational substrate. A later result can be traced to the HRA context it consumed without allowing the later result to rewrite that context. If HRA must change, it changes only through explicit re-declaration, not through downstream feedback.

8D.5 Minimal Relational Core with Later-Compatible Extension Surface

The fifth architectural effect is preservation of a minimal relational core with a later-compatible extension surface. The original HRA core remains small, stable, and priority-preserving: Self, Human Other, Nature, relational frame, Relational Triangle, directional channels, and communicative or perceptive force as structural availability.

The supplemental material creates an extension surface around that core. This extension surface clarifies how HRA can support downstream admissibility, routing, dyadic profiling, information-participation, agent-relative transduction, domain-description, entity-class, institutional, artificial-system, and evaluation architectures without becoming any of them. The resulting architecture is therefore neither frozen nor overexpanded. The HRA core remains minimal. The supplemental surface makes it compatible with the larger IntentLens stack. Downstream systems can build on HRA relational geometry while the HRA framework preserves its own boundary, authority, and non-feedback invariants.

### 9. Closing Statement

The present invention establishes the Human Relational Axes (HRA) as a foundational structural framework for representing relational positioning and communicative force in multi-agent systems. By defining a minimal and complete set of relational axes relative to a designated evaluator, the invention makes explicit the relational geometry within which influence may be considered, without embedding interpretation, evaluation, or outcome.

The HRA separate relational structure from semantic meaning, agent cognition, temporal authority, and evaluative judgment. This separation enables downstream systems to reason lawfully about admissibility, relevance, and consequence while preserving neutrality, auditability, and modular integration. Relational channels are represented as structurally available pathways of influence, distinct from the content that may traverse them and from the judgments applied to that content.

By treating communication as relational force situated within a perspectival but non-privileged frame, the invention provides a consistent and extensible basis for modeling interaction across human, institutional, artificial, and non-human agents. The framework accommodates direct communication, non-agentic constraint, and observational influence within a single unified representation, without requiring psychological inference or normative assumption.

Through these features, the Human Relational Axes supply a stable and general-purpose relational substrate that supports lawful interaction modeling across heterogeneous environments, while preserving clear boundaries between structure, interpretation, and evaluation.

### 9A. Supplemental Closing Statement

The supplemental material further clarifies that the Human Relational Axes operate as a minimal relational-positioning surface within a broader non-collapse architecture. The HRA framework may support later-developed downstream systems by supplying evaluator-relative relational context, axis placement, and directional channel structure, but such support does not expand HRA into the downstream systems that consume it.

In particular, downstream architectures may use HRA outputs in connection with communicative routing, declarative admissibility, dyadic interaction profiling, informational participation, agent-relative information transduction, domain description, entity-class stratification, evaluation, visibility, persistence, or action-preparation systems. Such use remains read-only with respect to HRA. The downstream system originates its own determinations under its own authority, and no downstream determination retroactively modifies the HRA relational frame.

The supplemental architecture therefore preserves one-way dependency. HRA outputs may flow downstream as relational context, but downstream outputs do not feed back into HRA by implication. Access, encounter, transduction, representation, packetization, admissibility, interaction-field activation, entity-class assignment, belief, truth, evaluation, persistence, visibility, or action does not rewrite HRA axis assignment, channel direction, channel existence, or evaluator designation.

This preserves the priority-core HRA invention while making explicit its compatibility with later refinements. The HRA core remains the minimal relational geometry of Self, Human Other, and Nature; the supplemental material defines a boundary-preserving extension surface by which that geometry may support heterogeneous downstream architectures without functional absorption, authority transfer, semantic inference, evaluative contamination, or layer collapse.

Through this supplemental clarification, the invention provides not only a foundational relational substrate, but also a stable upstream relational context that can participate in larger authority-segregated computational architectures while preserving its own non-authoritative, non-feedback-bearing, pre-interpretive character.

1. A system for representing relational structure in a multi-agent environment, the system comprising:
a relational framework defining a set of relational axes relative to a designated evaluator;
wherein the relational axes consist of exactly:
a Self axis corresponding to the evaluator position,
a Human Other axis corresponding to another subjectivity capable of reciprocal influence, and
a Nature axis corresponding to non-subjective forces exerting influence without consent;
wherein each agent or force present in a relational frame is assigned to one and only one of said axes relative to the evaluator;
and wherein the relational framework specifies directional relational channels along which communicative or perceptive force may be considered, without interpreting content, assigning authority, or determining outcome.

2. The system of claim 1, wherein the relational framework represents relational geometry independently of semantic content, such that identical content may exert different lawful effects solely due to differences in relational configuration.

3. The system of claim 1, wherein assignment to the Self axis is perspectival and frame-relative, and wherein any registered agent may occupy the Self position without modification to the relational framework.

4. The system of claim 1, wherein the relational axes are categorical and mutually exclusive at the level of representation, and collectively sufficient to situate all communicative and perceptive forces relative to the evaluator.

5. The system of claim 1, wherein the relational framework distinguishes agentic influence originating from a Human Other from non-agentic constraint originating from Nature.

6. The system of claim 1, wherein communicative and perceptive force are represented as directional relational channels that exist structurally independent of any particular utterance, action, or event.

7. The system of claim 6, wherein activation of a communicative act traverses an existing relational channel without creating or modifying said channel.

8. The system of claim 1, wherein the relational framework is non-evaluative and pre-interpretive, and does not assign permission, obligation, salience, or consequence.

9. The system of claim 1, wherein determinations of admissibility, relevance, participation, or outcome are explicitly deferred to downstream systems that consume the relational framework as read-only input.

10. The system of claim 1, wherein the relational framework is orthogonal to epistemic representation, agent cognition, and temporal ordering, and does not store history or advance time.

11. The system of claim 1, wherein the relational framework supports representation of observational relational forces arising from perception of interaction between entities other than the evaluator.

12. The system of claim 1, wherein the relational framework is compatible with heterogeneous evaluators, including human, institutional, artificial, or non-human agents, without asserting evaluator privilege or authority.

13. A computer-implemented relational-context preservation architecture comprising:
a relational-positioning structure configured to generate or receive relational-positioning output for a multi-entity environment, the relational-positioning output identifying at least a designated evaluator, an evaluator-relative relational frame, and one or more directional relational channels by which an entity, force, signal, artifact, condition, or structure is situated relative to the designated evaluator;
one or more downstream consumer architectures configured to consume the relational-positioning output as read-only relational context; and
a non-feedback preservation mechanism configured to prevent the one or more downstream consumer architectures from modifying, substituting for, or conferring authority upon the relational-positioning structure by virtue of downstream consumption of the relational-positioning output;
wherein downstream consumption of the relational-positioning output does not modify, substitute for, or confer authority upon the relational-positioning structure; and
wherein any modification of the relational-positioning structure requires an explicit re-declaration operation that creates or updates a relational-positioning structure independently of downstream consumption.

14. The architecture of claim 13, wherein the relational-positioning structure comprises a Human Relational Axes structure including evaluator-relative positions corresponding to Self, Human Other, and Nature.

15. The architecture of claim 13, wherein the relational-positioning structure is representation-invariant and may be implemented as a stored object, transient structure, dynamically reconstructed relation, graph structure, metadata record, distributed state, latent representation, vector representation, tensor representation, field-conditioned structure, declarative surface, or functional equivalent.

16. The architecture of claim 13, wherein the relational-positioning output includes axis placement, relational-frame identity, channel existence, and source-target directionality.

17. The architecture of claim 13, wherein a directional relational channel indicates structural availability of relational influence without indicating activation, transmission, encounter, transduction, interpretation, uptake, or effect.

18. The architecture of claim 13, wherein the one or more downstream consumer architectures comprise at least one communicative routing architecture configured to use the relational-positioning output without causing the relational-positioning structure to perform communicative routing.

19. The architecture of claim 13, wherein the one or more downstream consumer architectures comprise at least one declarative admissibility architecture configured to use the relational-positioning output without causing the relational-positioning structure to perform admissibility normalization.

20. The architecture of claim 13, wherein the one or more downstream consumer architectures comprise at least one dyadic interaction profiling architecture configured to use the relational-positioning output without causing the relational-positioning structure to construct a dyadic interaction profile.

21. The architecture of claim 13, wherein the one or more downstream consumer architectures comprise at least one agent-relative information transduction architecture configured to use the relational-positioning output without causing the relational-positioning structure to determine access, encounter, transduction, representation, payload formation, packet sealing, or downstream agent-internal participation.

22. The architecture of claim 13, wherein the one or more downstream consumer architectures comprise at least one entity-class stratification architecture configured to use the relational-positioning output without causing the relational-positioning structure to classify an entity as an interaction entity, continuant, agent, minded agent, institution, artifact, proxy, artificial system, or non-subjective system.

23. The architecture of claim 13, wherein the one or more downstream consumer architectures comprise at least one evaluative architecture configured to use the relational-positioning output without causing the relational-positioning structure to rank, score, prioritize, recommend, optimize, evaluate, or select an outcome.

24. The architecture of claim 13, wherein the non-feedback preservation mechanism prevents a downstream artifact, copy, derived object, profile, packet, admissibility declaration, routing output, domain output, evaluative observation, visibility state, persistence record, or action-preparation candidate from substituting for the relational-positioning structure.

25. The architecture of claim 13, wherein the explicit re-declaration operation requires declared structural input separate from downstream consumption before any evaluator designation, axis placement, relational-frame identity, channel existence, or channel direction is modified.

26. The architecture of claim 13, wherein the non-feedback preservation mechanism prevents downstream interpretation, evaluation, routing, admissibility determination, access determination, encounter determination, transduction result, packet formation, domain projection, visibility review, persistence review, action-preparation review, action selection, or execution from modifying the relational-positioning structure.

27. The architecture of claim 13, wherein the relational-positioning structure is prohibited from learning, adapting, normalizing, symmetrizing, temporalizing, escalating, attenuating, or recalibrating relational-positioning output based on downstream behavior, downstream outcome, repeated interaction, response, non-response, familiarity, or interaction history.

28. The architecture of claim 13, wherein inclusion of relational-positioning output within a downstream profile, packet, event primitive, domain profile, admissibility record, routing record, evaluative artifact, visibility artifact, persistence artifact, or action-preparation artifact does not convert the downstream artifact into the relational-positioning structure.

29. The architecture of claim 13, wherein the one or more downstream consumer architectures are prohibited from treating relational-positioning output as execution authority, routing authority, admissibility authority, event-admission authority, canonical existence authority, truth authority, belief authority, evaluative authority, persistence authority, visibility authority, or action authority.

30. The architecture of claim 13, wherein the relational-positioning output is prohibited from by itself gating, triggering, authorizing, blocking, prioritizing, routing, admitting, propagating, suppressing, preparing, selecting, or executing an action or event.

31. The architecture of claim 13, wherein the relational-positioning output is consumed as context only and any downstream act of gating, triggering, authorizing, blocking, prioritizing, routing, admitting, propagating, suppressing, preparing, selecting, or executing must originate from a downstream system having independent authority for such act.

32. The architecture of claim 13, wherein the non-feedback preservation mechanism preserves separation between channel existence and channel activation.

33. The architecture of claim 32, wherein channel activation does not imply encounter, encounter does not imply transduction, transduction does not imply representation, representation does not imply belief, and belief does not imply modification of the relational-positioning structure.

34. The architecture of claim 13, wherein non-activation of a directional relational channel is preserved as local silence and is not interpreted by the relational-positioning structure as refusal, consent, avoidance, agreement, disagreement, non-compliance, lack of relationship, or lack of capacity.

35. The architecture of claim 13, wherein the relational-positioning structure is prohibited from inferring subjectivity from institutional status, artificial-system output, automated responsiveness, fluent interaction, role performance, technical sophistication, repeated interaction, apparent autonomy, or communication-like behavior.

36. The architecture of claim 13, wherein communication-like mediation by an artifact, institution, proxy, automated system, interface, record, sign, or carrier does not cause the relational-positioning structure to classify the artifact, institution, proxy, automated system, interface, record, sign, or carrier as an agent.

37. The architecture of claim 13, wherein comprehension-like participation by an institution, artificial system, automated system, interface, proxy, or artifact does not cause the relational-positioning structure to classify the institution, artificial system, automated system, interface, proxy, or artifact as a minded agent.

38. The architecture of claim 13, wherein the relational-positioning structure preserves separation among perturbational influence, communicative transmission, and comprehension-like participation.

39. The architecture of claim 38, wherein perturbational influence from an environmental, biological, physical, computational, institutional, or non-agentic condition may be relationally situated without being classified by the relational-positioning structure as communication.

40. The architecture of claim 38, wherein environmental legibility may be relationally situated without being classified by the relational-positioning structure as agentive signaling.

41. The architecture of claim 13, wherein identical declared inputs to the relational-positioning structure produce identical relational-positioning outputs.

42. The architecture of claim 13, wherein relational-positioning output is inspectable by reference to declared inputs without requiring semantic inference, evaluative reasoning, downstream reconstruction, learned weighting, or hidden arbitration.

43. A computer-implemented method for preserving relational-positioning output during downstream consumption, the method comprising:
generating or receiving relational-positioning output identifying at least a designated evaluator, an evaluator-relative relational frame, and one or more directional relational channels by which an entity, force, signal, artifact, condition, or structure is situated relative to the designated evaluator;
exposing the relational-positioning output to one or more downstream consumer architectures as read-only relational context;
permitting the one or more downstream consumer architectures to consume the relational-positioning output under their own downstream authority;
preventing downstream consumption from modifying, substituting for, or conferring authority upon the relational-positioning structure; and
requiring an explicit re-declaration operation before evaluator designation, axis placement, relational-frame identity, channel existence, or channel direction is modified.

44. The method of claim 43, wherein exposing the relational-positioning output comprises exposing a representation-invariant relational-positioning structure implemented as a stored object, transient structure, dynamically reconstructed relation, graph structure, metadata record, distributed state, latent representation, vector representation, tensor representation, field-conditioned structure, declarative surface, or functional equivalent.

45. The method of claim 43, wherein preventing downstream consumption from modifying the relational-positioning structure comprises preventing a downstream profile, packet, admissibility declaration, routing output, evaluative observation, visibility state, persistence record, or action-preparation candidate from substituting for the relational-positioning structure.

46. The method of claim 43, further comprising preventing the relational-positioning output by itself from gating, triggering, authorizing, blocking, prioritizing, routing, admitting, propagating, suppressing, preparing, selecting, or executing an action or event.

47. The method of claim 43, further comprising preventing downstream interpretation, evaluation, routing, admissibility determination, access determination, encounter determination, transduction result, packet formation, domain projection, visibility review, persistence review, action-preparation review, action selection, or execution from modifying the relational-positioning structure.

48. The method of claim 43, further comprising preserving non-activation of a directional relational channel as local silence without interpreting the non-activation as refusal, consent, avoidance, agreement, disagreement, non-compliance, lack of relationship, or lack of capacity.

49. The method of claim 43, further comprising preventing subjectivity inference from institutional status, artificial-system output, automated responsiveness, fluent interaction, role performance, technical sophistication, repeated interaction, apparent autonomy, or communication-like behavior.

50. The method of claim 43, further comprising preserving separation among perturbational influence, communicative transmission, and comprehension-like participation during downstream consumption of the relational-positioning output.

51. A non-transitory computer-readable medium storing instructions that, when executed by one or more processors, cause the one or more processors to implement a relational-context preservation architecture comprising:
generating or receiving relational-positioning output identifying at least a designated evaluator, an evaluator-relative relational frame, and one or more directional relational channels by which an entity, force, signal, artifact, condition, or structure is situated relative to the designated evaluator;
exposing the relational-positioning output to one or more downstream consumer architectures as read-only relational context;
preventing downstream consumption of the relational-positioning output from modifying, substituting for, or conferring authority upon the relational-positioning structure; and
requiring explicit re-declaration before modifying evaluator designation, axis placement, relational-frame identity, channel existence, or channel direction.
